(19) United States
(12) Patent Application Publication
(10) Pub. No.: US 2012/0123817 A1
(43) Pub. Date: May 17, 2012

(54) AGRICULTURAL MANAGEMENT USING BIOLOGICAL SIGNALS

(75) Inventors: Joel Hohenberger, Lubbock, TX (US); Doug Sneed, Lubbock, TX (US); Tommy J. Martin, Lubbock, TX (US)

(73) Assignee: SMARTFIELD, INC., Lubbock, TX (US)

(21) Appl. No.: 13/294,857

(22) Filed: Nov. 11, 2011

Related U.S. Application Data
(60) Provisional application No. 61/413,163, filed on Nov. 12, 2010.

(51) Int. Cl. G06Q 10/00; G06Q 50/02

(52) U.S. Cl. 705/7.12

(57) ABSTRACT

A method and system for customizing agriculture management using biological signals and making decisions according to pre-programmed algorithms, including decisions related to irrigation, prediction of future yield, characterization of plant varieties, and administration of topical applications.

### CROSS REFERENCE TO RELATED APPLICATIONS

This application claims the benefit of priority from U.S. provisional patent application Ser. No. 61/413,163, filed Nov. 12, 2010, which is incorporated herein by reference in its entirety.

### BACKGROUND OF THE INVENTION

1. Field of the Invention

The disclosed invention relates to a method and system for assisting a grower in making effective crop management decisions.

2. Description of Related Art

Several crop management techniques have evolved over the years to help growers increase yield, predict the crop maturity date, and predict the value of their crop product. For example, a traditional method of predicting the crop harvest date is the “Days to Maturity” method. For many generations, growers have used this method to predict the time required for their crops to reach maturity. The particular “Days to Maturity” calculation, however, was typically based upon the type of crop that was being grown, but did not take into account the growing conditions, such as the ambient temperature during the growing season.

Another practice for predicting crop maturity that is becoming more common is the practice of rating crop maturity by determining “Growing Degree Days” (GDD) or “Heat Units.” Because each type of crop requires a specific number of GDD to reach maturity, regardless of the number of days taken to accumulate them, this method is more accurate than the “Days to Maturity” method that was traditionally used.

There are several ways of calculating GDD, however the most common method is to subtract the minimum growing temperature from the mean daily temperature. For example, when calculating the predicted maturity date for a crop such as corn, the following adjustments are employed:
1) temperatures below 50° F. are set at 50° F., and
2) temperatures above 86° F. are set at 86° F. This method of calculating GDD is often referred to as the (86,50) system. Following is the formula used to calculate GDD for a given day along with some sample calculations: GDD=(T High plus T Low) divided by 2, minus 50.

Example of a GDD Calculation:

For High=80° F., Low=60° F.: GDD=80 plus 60 divided by 2 minus 50=20 for that day.

Growing Degree Days or heat units are calculated for each day starting the day after planting. As an example, the total amount of GDD required for corn grown in the mid-west is 2,500. This calculation gives the grower a rough way to approximate how long it can take for the crop to mature. While GDD calculations recognize that daily temperatures above a certain level do not increase the speed at which the crops mature, the GDD methodology does not account for the negative impact of the crop's actual temperature (typically measured at the canopy) above its optimum. Although knowing a crop's heat units is extremely helpful in determining crop maturity, it is less helpful as a daily or weekly crop condition indicator and, consequently, less helpful as a decision making tool.

Another crop management practice, based on U.S. Pat. No. 5,539,637, involves monitoring crop canopy temperature using an infrared thermometer in an attempt to timely recognize if a crop is undergoing undue stress. If the crop is subjected to high ambient temperatures or low water levels, the result is a higher crop canopy temperature.

Determining plant health or condition is not, however, as easy as simply assessing crop canopy temperature at a given time. The question becomes how does one most effectively utilize that information to achieve desired crop outcomes? There is still a need for an improved method for using monitored crop temperature to determine crop health and stress levels so as to objectively and economically intervene to maximize crop outcome.

While crop canopy temperature can be used to determine if a crop is stressed, it can lead to over-intervention that is not cost effective based upon the crop health and yield. There is still a need for an effective way to translate this data into a prudent course of action. There is also a need for a method and system for effectively monitoring, analyzing and responding to crop temperature fluctuations in a way that achieves a desired crop outcome in an efficient manner.

### SUMMARY OF THE INVENTION

The present invention relates to a method, apparatus and system for monitoring, analyzing and responding to crop temperature fluctuations in a manner that maximizes desired crop outcome.

Disclosed is a method and system for effectively monitoring, analyzing and responding to crop temperatures and crop stress ranges.

It is an aspect of the disclosed invention to provide growers with data to determine a crop's health.

It is another aspect of the disclosed invention to provide growers with data ranges, such as, for example, data ranges of the daily temperature highs the crop canopy has experienced, an indication of the amount of stress the plant has been experiencing, the number of minutes per day that the crop is above optimal temperature, the amount of time per day that the crop canopy temperature has reached “high stress” or even “extreme stress” levels, etc., in order to enable them to see an overall picture of crop status.

It is an aspect of the disclosed invention to provide growers with data to determine a crop's maturity.

It is another aspect of the disclosed invention to help growers know when it is productive to initiate a crop management action as opposed to when it may not be productive to take action.

It is yet another aspect of the disclosed invention to enable a grower to make more informed crop management decisions as the crop is growing.

It is an aspect of the disclosed invention to help growers predict a crop's yield based on various measurements taken from the field including canopy temperatures.

It is a further aspect of the disclosed invention to enable growers to identify triggers that indicate the need for crop maintenance intervention, including but not limited to, irrigation.

It is an aspect of the disclosed invention to collect and process data to assist with prudent and objective decision making.

It is a aspect of the disclosed invention to provide a method for generating a crop management decision, the method comprising the steps: (a.) Collecting crop canopy temperatures at timed intervals, (b.) determining, with a computer system, a crop condition based at least in part on the collected canopy temperatures or a value derived therefrom, and (c.) generating, with the computer system, a management decision, wherein the management decision is selected from (i) a characterization of a plant variety, (ii) a decision to start or stop application of a topical application, wherein the topical application is a pesticide, growth regulator, growth hormone, herbicide or fungicide, and (iii) a prediction of future yield; or the method comprises the steps: (d.) collecting crop canopy temperatures at timed intervals, (e.) storing, in a computer readable format, a known crop specific optimum growing temperature, (f.) calculating, using a computer system, an accumulated stress score, (g.). determining, with the computer system, a crop condition based at least in part on the accumulated stress score or a value derived therefrom, and generating, with the computer system, a management decision.

It is a aspect of the disclosed invention to provide a system to monitor and respond to crop condition, comprising: (a.) one or more devices to collect crop canopy temperature at timed intervals, and (b.) a computer system, comprising: (i.) a processor; and (ii.) a computer readable medium having encoded thereon a set of instructions executable by the processor to cause the computer system to perform one or more operations, the set of instructions comprising: (A) instructions for receiving the collected crop canopy temperatures; instructions for a determining a crop condition based at least in part on the collected canopy temperatures or a value derived therefrom; and instruction for generating, a management decision, wherein the management decision is selected from (i) a characterization of a plant variety, (ii) a decision to start or stop application of a topical application, wherein the topical application is a pesticide, growth regulator, growth hormone, herbicide or fungicide, and (iii) a prediction of future yield; or the set of instructions comprising: (B) instructions for storing a known crop specific optimum growing temperatures or optimal canopy temperature, instructions for receiving the collected crop canopy temperatures, instructions for calculating an accumulated stress score, instructions for determining a crop condition based at least in part on the accumulated stress score or a value derived therefrom, and instructions for generating a management decision.

### BRIEF DESCRIPTION OF THE DRAWINGS

The drawings contained herein represent some of the embodiments of the invention and are not intended to limit the scope. For a detailed description of various embodiments, reference will now be made to the accompanying illustrative drawings in which:

FIG. 1 is a line graph (upper panel) and bar graph (lower panel) reflecting a two-week period of temperature measurement of a cotton crop which was irrigated with only 0.1 inches of water per day. Upper panel: dark line: ambient temperature; grey line: crop canopy temperature. Lower panel: bar graph indicating the crop canopy temperature above the optimal canopy temperature. The different coded regions of the bar graphs indicate differences in the amount of temperature stress the crop is undergoing. The bars are separated into several groups by the amount above optimal temperature—normal growth (no temperature stress), normal stress, high stress, or extreme stress, each of which is determined by set temperature ranges above the optimum canopy temperature.

FIG. 2 is a bar graph analysis showing a daily accumulated stress score of the area under the curve for the crop shown in FIG. 1, where each day's accumulated area under the curve (leaf canopy temperature in ° C. above optimum)×(minutes at the elevated temperature) is plotted, as tabulated in FIG. 8. The graph shows the daily accumulated amount of temperature-related stress the plant has experienced over the analysis period.

FIG. 3 is a line graph (upper panel) and bar graph (lower panel) reflecting a two-week period of temperature measurement of a cotton crop which was irrigated with 0.12 inches of water per day. Upper panel: dark line: ambient temperature; grey line: crop canopy temperature. Lower panel: bar graph indicating the canopy temperature above the optimal canopy temperature.

FIG. 4 is a bar graph analysis showing a daily accumulated stress score of the area under the curve for the crop shown in FIG. 3 (irrigated with 0.12 inches per day), where each day's accumulated area under the curve (leaf canopy temperature above optimum)×(minutes at the elevated temperature) is plotted.

FIG. 5 is a line graph (upper panel) and bar graph (lower panel) reflecting a two-week period of temperature measurement of a cotton crop. This crop was more heavily irrigated with 0.20 inches of water per day. Upper panel: dark line: ambient temperature; grey line: crop canopy temperature. Lower panel: bar graph indicating the temperature above the optimal temperature. Note that with adequate watering as shown in this figure, the leaf canopy temperature can be maintained near the optimal temperature.

FIG. 6 is a bar graph analysis showing a daily accumulated stress score of the area under the curve for the crop shown in FIG. 5 (0.20 inches of irrigation per day), where each day's accumulated area under the curve (leaf canopy temperature above optimum)×(minutes at the elevated temperature) is plotted.

FIG. 7 is a series of line graphs demonstrating a somewhat different method of determining the amount of stress that the plant is undergoing, as demonstrated with crops that were irrigated at either 0.10, 0.12, or 0.20 inches of water per day. This method, termed the “Smartfield stress index” or simply the “stress index”, is listed on the upper left corner of the figure. Briefly, the calculation is:

(((area under the observed canopy temperature but above the optimal temperature)÷(area under ambient temperature but above optimal temperature))−1)×100

wherein the area measurements are accumulated over a time, such as daily.

FIG. 8 is a line graph depicting the relationship between the amount of daily irrigation of a crop, the accumulated stress time, and the yield of cotton lint (in pounds per acre). The graph shows that decreased irrigation correlates with an increased accumulated daily stress time, which also correlates with lower yield.

FIG. 9 is a bar graph showing the results of an experiment of recording the accumulated stress on plants grown in three different locations within one field. The plants in Rep 1 were grown in the presence of a concentrated weed infestation. Intervention signals can be observed on the graph.

FIG. 10 is a bar graph showing the results of a regression trial. Three different cotton entries were grown under four different irrigation conditions and yield was measured for each trial.

FIG. 11 is a chart showing the results of the year-end yield forecast compared to the actual yield in a Water Regression Study. The chart shows the actual lint yield and the predicted yield for the different entries that were grown under the same management conditions at the end of the season.

FIG. 12 is a bar graph showing the predicted percentage of optimal yield of a regression trial wherein twelve cotton varieties were growth under nine different irrigation regimes. Averages of all entries are shown in a week to week yield forecast summary.

FIG. 13 is a bar graph showing the yield forecast averaged across entries for nine different irrigation regimes.

FIG. 14 contains a line graph showing the thermal pattern of two monocot entries after treatment with a topical application. Rainfall is represented by the bar graph at the bottom of the figure

FIG. 15 is a depiction of an example of the effect of a topical application on yield potential.

FIG. 16 is a depiction of an example of the effect of a topical application on yield potential. In the example chart, near optimal timing of the application of Treatment A resulted in a reduction of plant stress and as a result in an increase in yield for the treated entry of over 30%.

FIG. 17 is a depiction of an example of the effect of a topical application on yield potential. In the example chart shown, poor timing of the application of Treatment A resulted in minimal change to the plants stress levels. In this example, the grower's cost of the topical application would outweigh any benefit that he might receive.

FIG. 18 is a flow chart depicting one embodiment of a method of the invention.

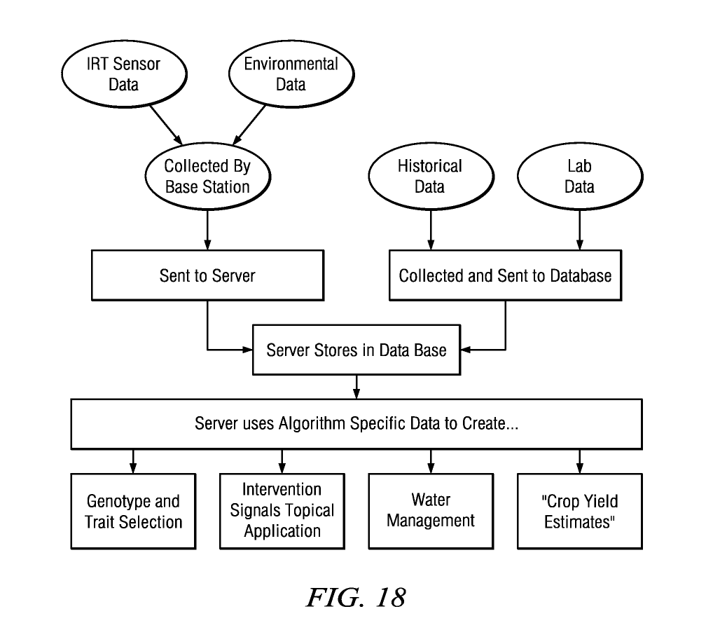

FIG. 19 is a schematic overview of the system in accordance with one embodiment of the invention.

FIG. 20 is a flowchart of the method and system of one embodiment of the invention.

FIG. 21 is a front view of the inside of the field base station in accordance with one embodiment of the invention.

FIG. 22 provides a schematic illustration of one embodiment of a computer system 200 that can perform the methods provided by various other embodiments, as described herein. It should be noted that FIG. 22 is meant only to provide a generalized illustration of various components, of which one or more (or none) of each may be utilized as appropriate. FIG. 22, therefore, broadly illustrates how individual system elements may be implemented in a relatively separated or relatively more integrated manner.

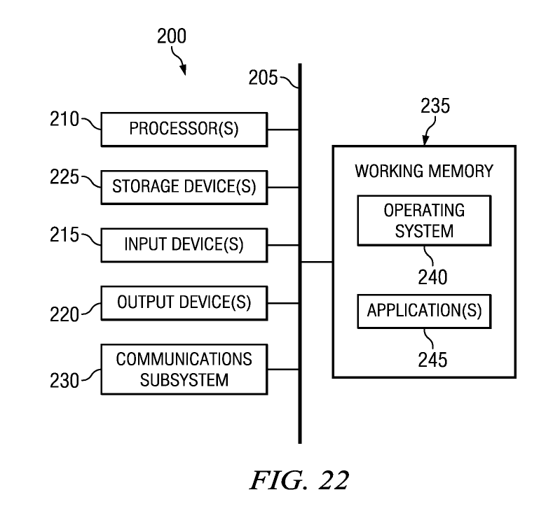

### DETAILED DESCRIPTION OF THE INVENTION

While a number of objectives for the current invention have been identified, they are not intended to limit the invention to methods and systems that are capable of achieving all or any particular stated objective.

Certain terms are used throughout the following description to refer to particular method components. As one skilled in the art will appreciate, design and manufacturing companies may refer to a component by different names. This document does not intend to distinguish between components that differ in name but not function.

In the following discussion, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more steps” combined together. Thus, a method can comprise an “entire method” or “sub-methods” within the method.

### DEFINITIONS

Accumulated Stress Count. The accumulated tally of the area under the curve of the observed crop canopy temperature but above the optimal canopy temperature for a given amount of time. The accumulated stress count (or score) can be accumulated, for example, on a per hour, per day, per season basis, or for any other suitable length of time.

Activity-Based Costing. A special costing model that identifies activities in an organization or system and assigns the cost of each activity with resources to all products and services according to the actual consumption by each.

Agronomic Trait. A phenotypic trait of a plant that contributes to the performance or economic value of the plant. Such traits include disease resistance, insect resistance, virus resistance, nematode resistance, drought tolerance, high salinity tolerance, yield, plant height, days to maturity, and the like.

Algorithm or Mathematical Model. Generally, this is a step-by-step set of rules for performing a calculation. Algorithms can be used for data processing, calculations, and automated reasoning procedures. As used herein, algorithms or mathematical models can be used for calculating diverse information, such as irrigation decisions, crop yield predictions, cost analysis, how an irrigation decision can affect yield, how an irrigation decision can affect predicted crop value, recognizing desirable traits in one plant compared to another plant, and decisions related to the application of topical applications.

Allele. Any of one or more alternative forms of a genetic sequence. In a diploid plant, the two alleles of a given gene occupy corresponding loci on a pair of homologous chromosomes.

Ambient Temperature. The temperature of the air surroundings. For an outdoor crop, this can be the temperature of the air surrounding the plant. This measurement is typically in either the Celsius (° C.) or Fahrenheit (° F.) scale.

Accessable system. Any system which allows a user to access information or data stored in a computer system, such as a web site, a separate processor with a remote link to the computer system, a portable graphic device, a telecommunication device or a display screen.

Canopy. The canopy of a plant or crop refers to one or more leaves of the plant or crop, wherein the leaves are directly or partially exposed. The canopy captures light energy through the process of photosynthesis, providing energy for plant growth.

Canopy Temperature or Crop Temperature. The temperature that the crop canopy is experiencing. This is often measured using an infrared thermometer on one or more leaves of a plant. This temperature generally changes throughout the daily cycle. When the ambient temperature is lower, the crop canopy can often follow the ambient temperature, while at higher temperatures, such as during the highest heat of the day, a plant canopy may or may not be able to maintain a specific temperature. Under optimal conditions, the plant can maintain a desired temperature. However, under suboptimal conditions, such as low water availability, the temperature of the plant canopy may increase towards the ambient temperature.

Crop. A plant that is grown or cultivated to be harvested for an economic purpose.

Crop Condition (or crop health). The general condition of the plurality of plants in a field, whether they are growing at their optimum rate, or whether they are undergoing or have undergone any stresses during any phase of their life cycle. A major factor in crop condition is whether the crop has been watered adequately on a daily basis throughout its growing season.

Crop Impact. The overall influence or effect of a variable on the growth of a crop. An event, such as a period of plant temperature stress, or other stress, may have a long-term impact on the yield of the crop, or may result in the slowing of the general growth rate of the plant. An event may also have an effect that is only short-term or negligible to the final yield of the plant.

Crop Specific Growing Temperature. The optimal temperature (or temperature range) that allows the best growth for a given plant type. Different plant types can have different optimal temperatures.

Cultivar. A variant member of a species. Members of a particular cultivar are not necessarily genetically identical. In general, a cultivar is an assemblage of plants that has been selected for a particular characteristic or combination of characteristics, is distinct, uniform and stable in those characteristics, and retains those characteristics when propagated. The terms cultivar and variety are often used interchangeably.

Genetic Differences. Differences in the DNA sequence in at least one location in the plant's genomic, plastid, or mitochondrial DNA. This difference can lead to such changes as an altered gene, an altered gene expression pattern, altered protein expression, altered protein function, altered phenotype, and altered environmental stability, such as, for example, an alteration in the plant's susceptibility or resistance to temperature stress and/or water deficit stress.

Growing Degree Days (GDD). A measure of the heat accumulation over days to predict when a crop will reach maturity. One measurement involves subtracting the minimum growing temperature from the mean daily temperature. The base temperature is that temperature below which plant growth is zero. The GDDs can be determined each day as maximum temperature plus the minimum temperature divided by 2 (or the mean temperature), minus the base temperature. The units are accumulated by adding each day's GDD contribution as the season progresses. The determination of GDD to maturity can differ for different plant varieties.

Graphical Display. A graphic visual representation of information, data or knowledge, for example, in the form of a chart, graph or figure. A graphical display can be on any type of media, including electronic displays or paper.

Heat Units. Heat units, which are similar to GDD, are a commonly used method to assist in the prediction of the maturity date of a crop. Heat units are a measure of time corrected for the environmental effect of temperature. Heat units typically begin to accumulate at planting and continue to accumulate daily until the date of plant harvest.

Irrigation Decision. A decision to change the watering schedule of a crop. This can be a decision to start watering or stop watering. It can also be a decision to slow or increase the flow of watering, or to change the amount of water that reaches the plant per day or over a period of time. It can be a decision to change the time of day the watering is performed. The irrigation decision can be acted upon immediately, or may be delayed. The irrigation decision can be performed by a human, such as the grower, or by an automated method, determined by calculations from a computer or other device.

Management Decision. A decision regarding the management of the crop. This can be a short term decision, such as turning the irrigation on or off, or it can be a long term decision, such as allowing a crop to undergo a certain amount of plant stress in order to save water. The management decision is not limited to determining the timing and application of irrigation, however. The management decision can be related to predicting future yield, the timing and application of pesticides, growth regulators, growth hormones, herbicides or fungicides. The management decision can also be related to alerting additional entities, such as investors, insurance companies, agricultural management experts, and the like.

Microprocessor. A microprocessor incorporates the functions of a computer's central processing unit (CPU) on an integrated circuit or microchip. It is a multipurpose, programmable, electronic device that processes input binary data and provides the results as output.

Mutation. An altered genetic structure of the DNA of an organism. In plants, a mutation can be a point mutation, a deletion of a gene or portion thereof, or other changes to the DNA of the plant. An altered phenotype, such as growth changes, morphological changes, or an altered response to environmental conditions, such as, for example, an altered response to water deficit, can occur in the plant having the mutation.

Optimum Canopy Temperature. This refers to the optimal temperature at which plant growth and various aspects of metabolism are coordinated in such a manner that the performance of the plant is not limited by temperature. In general, this is the temperature at which vegetative plant growth occurs the fastest. At this temperature, the plant can perform photosynthesis quickly, and can accumulate assimilate at a high rate. The end result of this increased photosynthesis and assimilate accumulation is a higher rate of vegetative growth and final yield of the plant.

Optimal Canopy Temperature Range for Growth of a Crop. This is generally the temperature range at which a crop has the highest rate of photosynthesis and vegetative growth during the growing season. Some plant types may have a narrow range, such as 1° C. to 2° C., while other plant types may have a broad range, such as 5° C. to 10° C., or more.

Optimum Growth. This term generally refers to the optimal vegetative growth of a plant. This can be measured, for example, by the yield of total plant material, the yield of a specific product of the plant, the plant height, plant growth per day, total leaf area, total plant weight, or by other suitable means. The term can also refer to optimum yield of a commercial product derived from the plant (such as, for example, fruit, seeds, etc.).

Plant Stress. Environmental conditions that somewhat decrease or inhibit the ability of the plant to grow and develop efficiently to its full capacity. The stress can be an abiotic stress or a biotic stress. Examples of abiotic stress include, but are not limited to, heat stress, cold stress, wind-stress, stress from poor soil or the presence of contaminants, freezing stress, or water-related stresses such as water deficit stress, drought stress, or stress from too much water in the soil. A plant stress condition can occur occasionally, sporadically, commonly, or constantly.

Plant Variety. A plant variety is a plant grouping within a single botanical species. Although two different varieties within a species would both be grouped as being members of one specific species, each of them contains at least one genetic difference or phenotypic difference from any other variety of the same species.

Reimann Sum. This describes a method for approximating the total area underneath a curve on a graph. This term is also known as an “integral”. This method can be used, for example, to determine the area under the curve for the “accumulated stress count” or the “Smartfield Stress Index” or other plant stress analysis models described herein.

Smartfield Stress Index or Stress Index (SSI). This is a ratio which compares plant canopy temperature and ambient temperature of a given field, using a “Reimann sum” method. The SSI uses the optimum plant canopy temperature, or optimal growing temperature, of the plant as a baseline for the temperature measurements. SSI provides information regarding plant stress that is independent of factors such as relative humidity. The general calculation is:

(((the area under the observed canopy temperature and above the optimal canopy temperature) divided by (the area under ambient temperature and above optimal temperature)) minus 1)×100

Specialized Water Management Organization. A specialized water management organization can be broadly defined as a social organization aiming at an appropriate use of water for irrigation purposes among the farmers and other water users (such as residents, businesses, golf courses, or other commercial entities), in a community.

Stress range grouping. Non-Stressed (normal growth), Normal Stress, High Stress, or Extreme Stress. As used herein, these terms are used to indicate the relative degree of harm a plant canopy is exposed to by having an elevated temperature above its optimum canopy temperature or optimal growing temperature. This amount can differ with different crop types or different plant varieties. A non-stressed plant is at or near the optimal canopy temperature, and is thus undergoing no temperature stress. Normal stress is a slight temperature elevation above the optimal. High stress is a higher temperature above the optimal. Extreme stress is a canopy temperature that is much higher than “high stress”—at this temperature the plant can die, or the yield of the crop may be severely damaged. The range of temperatures for each of these stages can be determined by the user, depending on the specific crop and other parameters.

Timed Intervals. A definite length of time marked off by two instants. As used herein, the various crop sensors are set to take readings at specific timed intervals. The timed intervals can be changed as needed. Timed intervals can be set, for example, at every 0.25 second, every 0.5 second, every second, every thirty seconds, every minute, every 5 minutes, every 15 minutes, every 30 minutes, every hour, or more, as desired. There can also be timed intervals, for example, for transmitting the data from a sensor to a crop field station, transmitting the data from the field station to the central processing unit, performing data analysis, sending the information to the user, and sending the information to an irrigation control device. Different crop sensors and different data input information can have different timed intervals, if desired.

As an example of using various timed intervals for different aspects of the crop monitoring and analysis process, in an embodiment, the leaf temperature sensor can take readings at timed intervals of every 1 minute, while the ambient temperature sensor takes readings at timed intervals of every 5 minutes. The data is transmitted to the field station at timed intervals of every minute. The readings for several different leaf temperature sensors throughout the field are collected by the field station, for example, every 5 minutes, and then transmitted to the central processor, for example, every 5 minutes. The central processor can analyze the data, for example, every 15 minutes, and can update the results on a website display at a timed interval of every 30 minutes.

Topical Application. Any application to a crop or field, including but not limited to herbicide, pesticide, growth hormone, growth regulator, and fungicide.

Transgene. A nucleic acid segment that is present in a plant genome, which is normally not present in that plant genome. The nucleic acid segment can be, for example, a gene, a fragment of a gene, an antisense sequence, an RNAi-type sequence, and the like. The nucleic acid sequence can be synthetically derived, or can be derived from another type of organism, another species, or another plant.

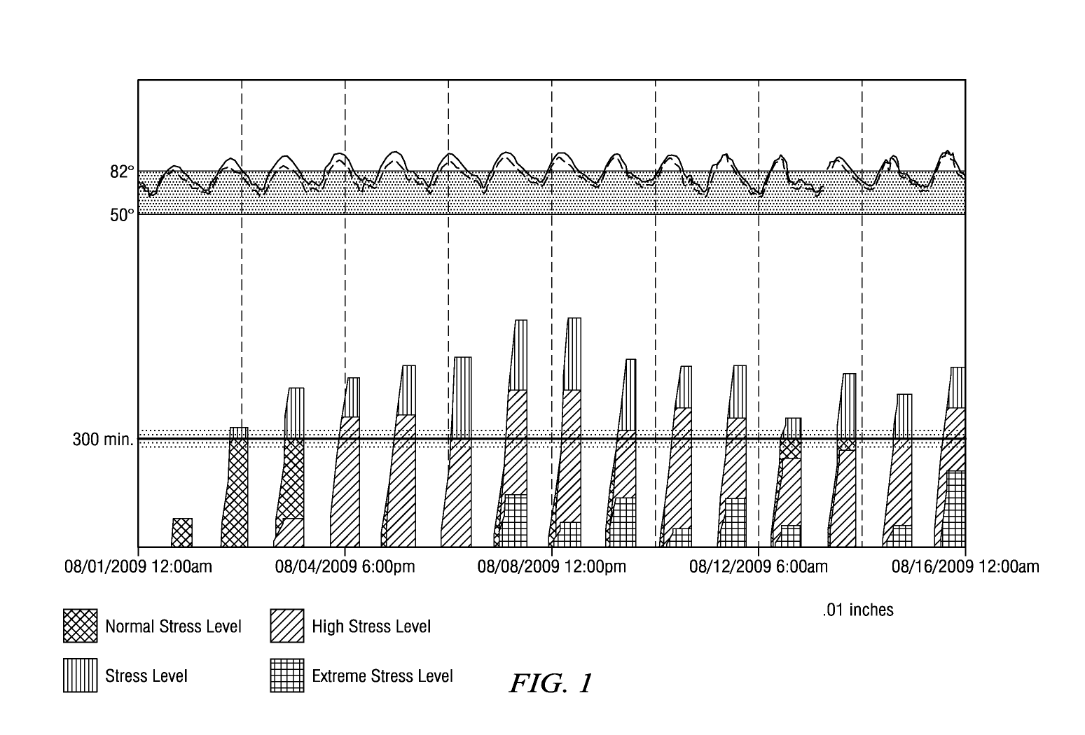

Trigger. A pre-determined numerical value at which a decision is made to provide an alert to the user (such as a grower or a management entity) regarding a crop management decision, or to automatically initiate a crop management decision, such as the initiation of irrigation. The trigger value can indicate a degree of plant stress that the plant is experiencing due to water deficit and high leaf temperature. The trigger value can be based on various types of calculations, such as those described herein. The trigger can be based, for example, on a calculation of the accumulated time above optimum and the number of degrees above an optimal temperature for a given day, week, or even for the entire crop growing season. The trigger can be based on the accumulated area under the curve between the optimal temperature and the canopy temperature (such as shown in FIG. 1, and in Table II, columns 6-8, for example). The trigger can also be based on a value determined from the “Smartfield Stress Index”, or “stress index”. The trigger value can also be based on analysis that involve predictions, such as, for example, predictions of future weather patterns, future water availability, future water costs, future energy costs, future crop prices, and the like.

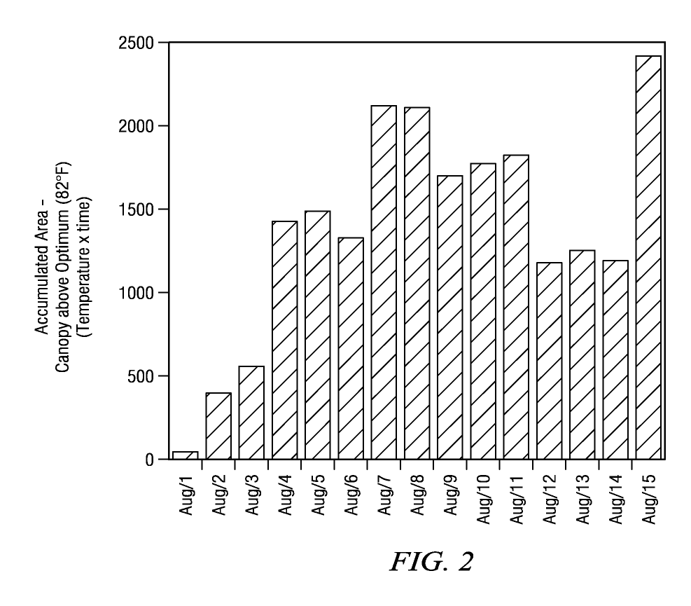

As an example of how a grower might set or change a trigger value, see FIG. 2. In this example, a low amount of irrigation was used, and the plants were stressed throughout the growing season. This would likely result in a much lower yield. If, for example, the grower of the crop shown in FIG. 2 had decided, instead, that he did not want the crop to be so stressed that it would have a significantly lower yield, he could have set the trigger level so that an alert would be sent to automatically initiate irrigation whenever an accumulated area count of, for example, 1500 was reached in any day during the season. In the case of the crop analyzed in FIG. 2, this trigger of 1,500 would have resulted in the application of additional irrigation for 7 of the 15 days in the study.

User. In general, the user is the pre-determined person or entity that is to be notified upon a trigger alert. The user can be the grower, a field worker, an agricultural management company, an agricultural insurance company, an investor, or any other person who is pre-determined to be notified of an alert. The user can also be a non-human entity, such as an irrigation control device, a remote irrigation control device, a communications device, and the like.

Water Stressed or “Water Deficit Stress”. A decreased ability of the plant to perform physiological functions at its normal rate, due to an inadequate supply of water to the plant. The stress period that the plant experiences can vary widely. For example, the period of water stress can be a few minutes, to hours, to days, or can be intermittent, or constant. In many situations, water stress can lead to higher canopy temperatures. The plant may or may not be able to adjust to the water stress.

Web Server. The general term “Web server” can refer to either the computer (hardware) or the computer application (software) involved in the content delivery. Web servers can host web sites, and can also be involved in data storage, running enterprise applications, or other uses.

Yield. The yield is typically the total weight of an agronomic product, such as a grain or a fruit, or the biomass of a plant at harvest. This can be measured, for example, on a per area basis, on a per plant basis, on a per day basis, or a per season basis. In some embodiments, the yield can also be measured as the weight per plant, or the weight of vegetative material or biomass of a plant, either at the end of the growing period, or at specific time points during growth.

The optimal canopy temperature for a specific plant variety or cultivar can be determined by several means. In some embodiments, a crop's optimum canopy temperature can be determined using the method and system disclosed in U.S. Pat. No. 5,539,637, the content of which is expressly incorporated herein, or by any other suitable means.

Crop canopy temperature can be correlated with the overall health of the crop. Much in the way a human operates most effectively when the body is kept in an optimum temperature range, so does a plant. As a result, technology has responded with various devices to measure a crop's temperature. As an example, infrared sensors are now used to measure crop canopy temperature, giving an effective indicator of the plant's leaf temperature.

In some embodiments, it may not always be prudent for a grower to intervene, for example, to irrigate, just because of an isolated crop canopy temperature that is above optimum. In some embodiments, the grower needs to know what effect his management decision will have on his ultimate bottom line. For example, it may not be economical to spend money to irrigate a crop even if its canopy temperature has been above optimal for an extended period of time if the crop is only mildly stressed and has not been subjected to significant stress over the growing season. To make prudent management decisions, the grower needs sophisticated data with triggers so the grower can better determine the cumulative amount of stress that a crop has been subjected to and what effect this stress will have on yield.

In some embodiments, it is instructive for the grower to have at his disposal a way of knowing not only whether his crop was above its optimum growing temperature or optimal canopy temperature on any given day, but also for how long the crop was above the optimum growing temperature or optimal canopy temperature and to what ranges above optimum the canopy temperature climbed. This data can then be analyzed in light of crop specific parameters. Tracking this information, analyzing the collected data, and reacting with a responsive watering plan can drastically affect ultimate crop yield. This data, when providing the grower with triggers for action, helps the grower determine when it might be a waste of resources to intervene because the intervention might not significantly impact the final yield. For example, if a crop's optimum temperature is 82° F., as is generally the case with cotton, then it is instructive to know not only whether the plant has been subjected to higher temperatures than the optimum, but also for how long and in what range the higher temperatures occurred.

In studies conducted by the inventors, crops subjected to temperatures well above optimum, for longer periods of time, resulted in far less desirable yields. However, the crop yield was found to be more closely correlated to the cumulative amount of stress that the crops were subjected to as compared with the crop temperature or overall time the crop was being stressed. In some embodiments, utilizing this information proves a powerful tool for a grower in that he will know when to timely intervene to lower crop temperature, using interventions such as irrigation. The same approach may be used with regard to other agricultural management decisions (including but not limited to predicting future yield, as well as the timing and application of pesticides, growth regulators, growth hormones, herbicides, and the like) and is not limited to determining the timing and application of irrigation.

The disclosed method and system has proven greatly beneficial to plant breeders, growers, researchers and agricultural consultants, in that the collected data can be used to characterization of plant varieties, select optimum genetic varieties, predict outcomes and adjust management styles.

Growers instinctively tend to overwater during long summer days, fearing their crops are drying up under the heat. Overwatering results from the grower's inability to determine precisely when crops need additional irrigation as well as inadequate information as to the relative effects of over and under watering the crops. Moderate overwatering generally does not have a significant adverse impact on the crops themselves although it is both economically and environmentally wasteful. In contrast, under watering by even a small amount can have significant consequences on the overall crop yield. As a result, it is not surprising that growers err well on the side of overwatering their crops. Having an objective way to determine water needs, by analyzing temperatures, plotting ranges above optimum and determining periods of time the crop temperature stayed above optimum, gives the grower an objective tool to determine not only when it is critical to water but also when it is not particularly productive to water. Watering when conditions do not indicate the need is extremely expensive for the grower and unnecessarily depletes a critical resource.

### Devices for Measurement

In response to growers' needs to have accurate objective data and triggers at their fingertips, the inventors have developed a method and system for monitoring, analyzing and responding to crop temperature fluctuations to achieve a desired crop outcome with the least consumption of grower resources.

In an embodiment, several devices that can measure and collect crop canopy temperature, such as an infrared thermometer, or other suitable canopy temperature measurement device, are placed at intervals throughout the field. The devices can be programmed to collect temperatures at specific timed intervals which may be as often as every 5 minutes or any interval of time desired. The devices may be set, for example, to collect temperatures at intervals from about every 15 seconds, 30 seconds, every minute, 2 minutes, 4 minutes, 6 minutes, 10 minutes, 15 minutes, 30 minutes, 45 minutes, or 1 hour or more. Several readings can be averaged into one data point, if desired. In an embodiment, 1 minute readings are taken and averaged every 15 minutes into a single data point.

In an embodiment, at least one device that can measure the ambient temperature is also placed in the field. Concurrently, ambient temperatures and other weather data can be collected in the field at timed intervals. Alternatively, ambient temperature and weather data can be collected from other sources. In an embodiment, the device that measures the canopy temperature is also the device that measures the ambient temperature. The data collection can be analyzed, for example, every 30 minutes, every hour, every 2 hours, every 3 hours, every 6 hours, every 12 hours, every 16 hours, every 24 hours, or more, if desired. In some embodiments, the data is relayed by any suitable means, such as by using cellular or another radio frequency transmission, to a microprocessor or to a web server for storage and analysis. In some embodiments, the transmission antenna for each device can be located so as to minimize interference from the crop as well as to avoid interfering with any irrigation equipment.

### Data Analysis

In an embodiment, the disclosed invention includes software that analyzes and plots the collected canopy temperatures, ambient temperature, and the specific crop's optimum growing temperature or optimal canopy temperature against time, in order to generate a crop yield predictor, a crop health indicator or a crop maturity indicator determined from the overall accumulated stress of the crop. The information received from the crop, or “input data”, can be analyzed using a number of mathematical models such as the calculations described herein, in order to determine the amount of crop stress, and whether an irrigation decision or other management decision should be made. The collected data from the field, as well as the resulting information from the crop stress calculations, can be remotely obtained, if desired, by logging into a web server.

In some embodiments, the microprocessor or web server has preloaded data containing relevant known optimum temperatures for the specific crop being monitored. The known optimum temperature can be determined using, for example, the method described in U.S. Pat. No. 5,539,637, the content of which is incorporated herein.

In an embodiment, selective data such as predetermined trigger alerts can be transmitted directly to the grower via cell phones, text messages, email alerts, voicemail alerts, SMS alerts or other communication methods. This information can then be used by the grower to make crop management decisions, such as irrigation timing and amount. In some situations, the trigger alert should be acted upon immediately. Accordingly, the trigger alerts can also be arranged to be sent to an automated irrigation control device or a remote irrigation control device. The alert can also be sent to another entity. Exemplary entities to receive an alert can include, but are not limited to, an agricultural management service, an agricultural insurance company, a crop investment group, a local water authority, an irrigation organization, another requested entity, and the like. In one embodiment, the user may request that the system run in a “silent mode” wherein no trigger alerts are sent. In one embodiment, the “silent mode” may be for a predetermine period of time.

In an embodiment, an information summary or update of the crop information can also be sent to the grower or other entity as often as desired, even if no alert has been triggered. The information summary can be sent, for example, every 30 minutes, hourly, twice daily, daily, weekly, monthly, or longer. The information summary can be sent by any suitable means. Exemplary methods of sending the information summary include but are not limited to email, cell phone, phone message, pager, text message, internet access, website display, instant message, or other system, as desired.

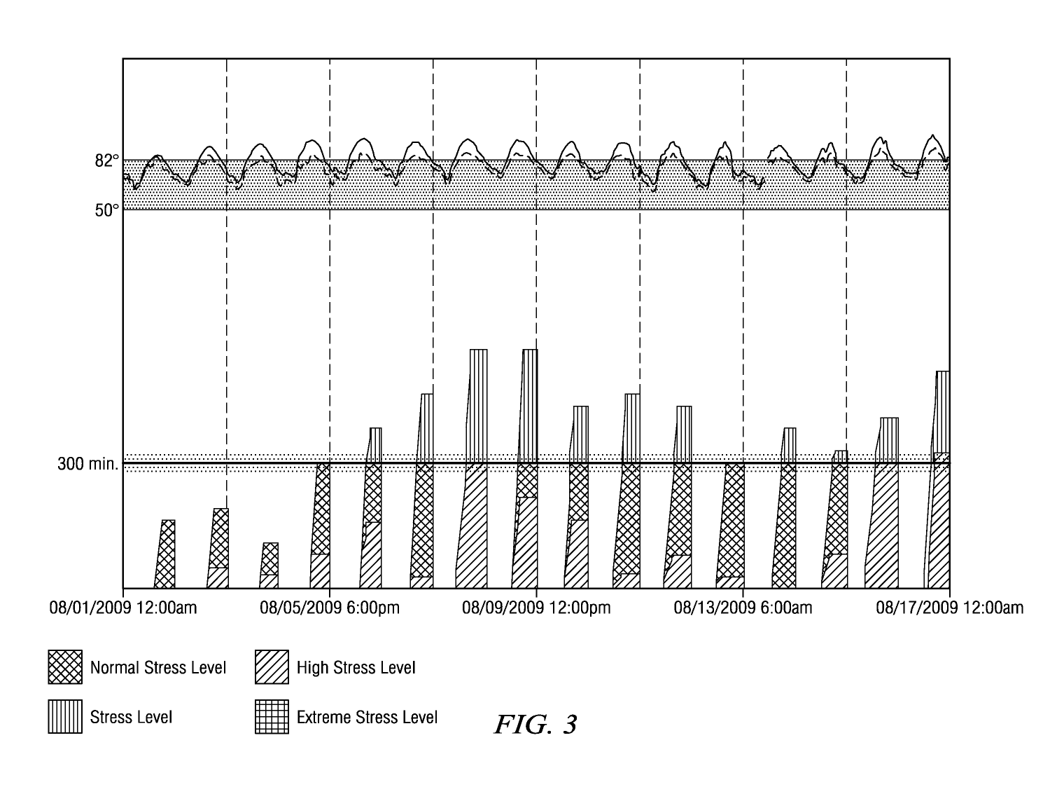

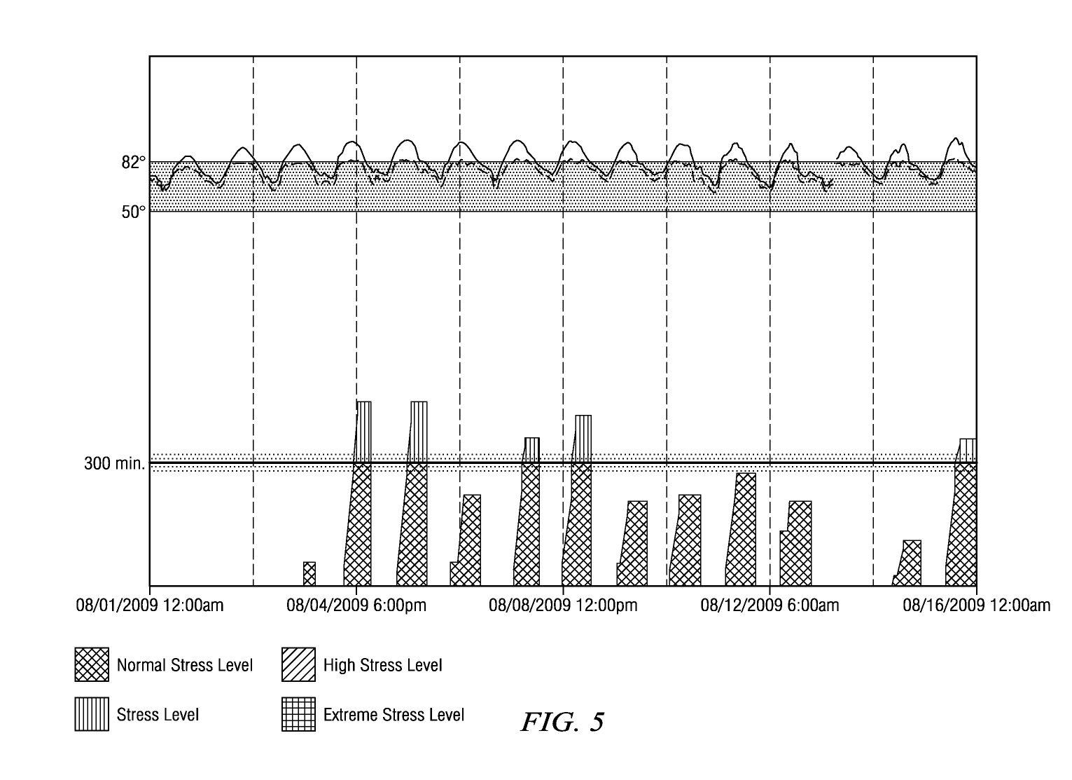

In some embodiments, also preloaded is algorithm-controlled software that is capable of plotting the ambient temperatures and the crop canopy temperatures against length of time at a given temperature, such as shown in FIG. 1, FIG. 3, and FIG. 5, top panel.

In an embodiment, the ambient and crop canopy temperatures are plotted against the optimum growing temperature or optimal canopy temperature of the given crop, as shown in the bottom panel of FIG. 1, FIG. 3, and FIG. 5. These plots can be used to identify when the crop has been subjected to predetermined cumulative amounts of stress. The plots and algorithms can also be used to generate triggers to identify and easily visualize when a grower should optimally intervene with additional irrigation in order to reduce crop stress and to maximize crop yield in an economical fashion.

### Crop Stress—Data Analysis Methods

Several data analysis methods can be used to determine the level of crop stress and to calculate a numerical trigger to alert the grower. Three methods that can be used are discussed below: 1) dividing the stress into “layers” or “stress level groups” to better determine the degree of heat damage the leaf is experiencing; 2) the “Smartfield Stress Index”, which factors in both leaf temperature and ambient temperature; and 3) the “Accumulated area stress count”, which is the area under the curve of the leaf temperature but above the optimal temperature for an amount of time (this method factors in both the elevated temperature and the time at that temperature). Data Analysis Method 1): Separate the observed canopy temperature into discrete stress level groups (such as by Normal Growth, Normal Stress, High Stress, and Extreme Stress) based on the degrees above optimal

In an embodiment, a method for determining accumulated temperature stress involves rating the temperature a crop canopy is experiencing into several discrete groups, in order to better characterize the degree of heat stress the crop is experiencing. In an embodiment, the discrete groups are: non-stressed (that is, normal growth, crop at optimal canopy temperature), normal stress, high stress, or extreme stress. This range can be different for different plant types, and can be determined by several means, such as, for example, by the previous experience of the grower, by reviewing the literature, by examining historical crop data, or by other means. In this method, the temperatures above optimal growing temperature or optimum canopy temperature are plotted in a series of discrete levels (rather than simply listing the observed canopy temperature) over a period of time. The different levels can be color coded, or can be otherwise coded, on a graphical representation to allow easy visualization of the stress level the crop has experienced. The resulting graph displays the length of time that a crop has experienced various discrete levels of temperature stress, as determined by how high the canopy temperature is in relation to its biological optimum.

Cotton can be used as a general example. Cotton plants generally have a biological optimum of 28° C. (82° F.). Thus, normal or “optimal” growth occurs at 28° C. At this crop canopy temperature, the plant is not temperature-stressed (“normal growth”). When the crop canopy temperature exceeds 28° C., the cotton plant is considered to be experiencing some degree of temperature stress. When the canopy temperature is between 28° C. and 30° C., the cotton plant is experiencing “normal stress”. High stress for cotton crops can be defined, for example, as any amount of time the canopy temperature exceeds 30° C. (86° F.), and extreme stress can be defined, for example, as any amount of time the cotton crop canopy temperature exceeds 33° C. (91° F.). When visualized on a graph, such as shown in FIG. 1, these different discrete levels can be color coded or pattern coded so that one can easily see when the crop is or has been at a dangerous temperature stress level.

For different crops, the optimum growing temperature and optimum canopy temperature can be different, as well as the temperature settings for normal stress, high stress, and extreme stress.

In some embodiments, the method is very flexible, so that the individual growers can set the triggers for an alert as they desire.

These discrete temperature stress level settings can also be adjusted based on empirical data on crop yield for a particular field or similarly situated fields over subsequent growing seasons. These settings may also be adjusted for economics, such as the expected value of additional crop yield as compared to the production cost associated with that yield increase. The settings may also be adjusted as needed at different times in the plant life cycle. For example, sensitive growth periods, such as germination, flowering, fruit set, or fruit/crop maturation may require changes in the discrete temperature stress settings, depending on the crop. The algorithms then calculate accumulated stress time which can be used to measure crop health, irrigation needs, other input needs, crop status and to project yield based on the trends reflected in the graphs.

As an example of the different discrete temperature stress groups that a grower might assign to different crops, for example, see the table below.

TABLE I
Examples of the use of different stress
range settings for different plant types

| | | Normal | | | |
|---|---|---|---|---|---|
| | Optimal | Growth | Normal | High | Extreme |
| Plant | Temperature | (non-stressed) | Stress | Stress | Stress |
| type | (° C.) | (° C.) | (° C.) | (° C.) | (° C.) |
| A | 28 | ≦28 | 28-30 | 30-35 | >35 |
| B | 26 | ≦26 | 26-28 | 28-30 | >30 |
| C | 27.5 | ≦27.5 | 27.5-28 | 28-32 | >32 |
| D | 23 | ≦23 | 23-27 | 27-28 | >28 |
| E | 30 | ≦30 | 30-32 | 32-37 | >37 |

In some embodiments, knowing this information enables the grower to decide whether to irrigate or initiate other management decisions, whether corrective action is needed in the field and what the appropriate action would be. For example, the data may indicate that a crop lingering at a certain level above optimum growing temperature or optimum canopy temperature range for a certain period of time may not create sufficient stress to significantly decrease crop yields. As a result, perhaps intervention with water in that scenario would be unwarranted and would even be a wasteful action. The disclosed method and system removes subjectivity and emotion from the watering decision and gives the grower critical objective data on which to base his crop interventions, including triggers indicating when action is advised.

In some embodiments, for example, a trigger for an alert to the grower can be sent when the plant is at “high stress” for greater than an hour; but a trigger for an immediate alert to be sent to the grower whenever the plant is experiencing “extreme stress”.

In an embodiment, the grower can arrange the system so that during early growth, even a “normal stress” of about 30 minutes is a trigger to alert the grower to irrigate, while later in the growth cycle, the system can be altered so that a trigger occurs only after several hours of heat stress.

Because the system is very flexible, the grower can arrange the system so that an alert is triggered after any amount of time and/or temperature stress, and from any chosen algorithm or mathematical model.

Thus, an alert trigger can be set, for example, when a crop reaches the “high stress” group for 30 minutes, or 1 hour, 2 hours, 3 hours, 4 hours, 6 hours, or 8 hours, or more. Similarly, an alert trigger can be set, for example, to notify the grower or turn on irrigation when a crop reaches the “extreme stress” range group for more than 15 minutes, more than 30 minutes, or 1 hour, 2 hours, 3 hours, 4 hours, 6 hours, 8 hours, or more. An alert trigger can be set, for example, when a crop canopy temperature is in the “normal stress” group for a certain amount of time, such as for 4 hours each day for 3 days, or 2 hours each day for 2 days, etc. For plants that may be particularly heat sensitive, the alert trigger can be set, for example, to alert the grower when the plant is at “normal stress” for more than a certain amount of time, such as, for example, 1 hour, 2 hours, 3 hours, 4 hours, or more.

### Data Analysis Method 2): Smartfield Stress Index

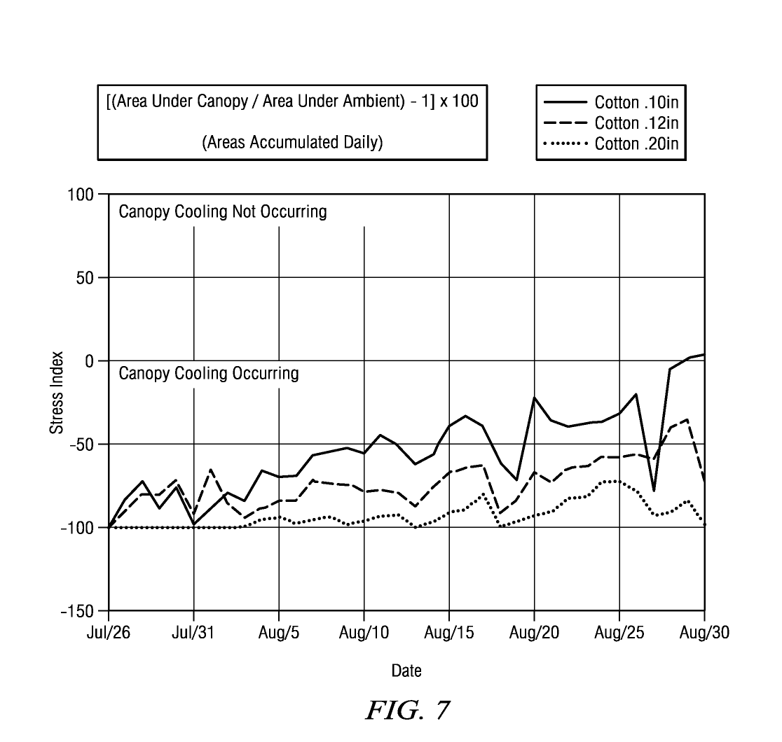

In another embodiment, an alternative mathematical model for determining accumulated crop stress can be used. The calculation for this method is somewhat more complicated; it factors in not only the crop canopy temperature, but also the ambient temperature. The use of this model is shown in FIG. 7. This method has been named the Smartfield Stress Index or “Stress Index”. In this method, a Reimann sum method is used to calculate 1) the area under the canopy temperature and above the optimum growing temperature or optimum canopy temperature for the crop; and 2) the area under the ambient temperature and above the optimum growing temperature or optimum canopy temperature of the crop. For each period of time, such as, for example, each day, the following equation can be used to quantify the plant's performance and condition:

[(Area under canopy temperature but above optimum canopy temperature/Area under ambient temperature but above optimum temperature)−1]×100]

In some embodiments, using the Stress Index, values of −70 and less result in improved yield and improved water efficiency. For a plant with little or no stress, the Stress Index will approach −100. As the Stress Index approaches a value of zero, the plant loses its ability to cool itself using available water. At a value of zero, the plant has no ability to cool itself. At values greater than zero, the canopy is actually hotter than the ambient temperature. This is an extreme stress condition for the plant. On the FIG. 7 graph, for example, the cotton crop given only 0.10 inches of irrigation exhibited much greater stress, having a value over zero on August 30, as opposed to the cotton given 0.20 inches of irrigation which had a value of −90 on August 30. In an embodiment, the calculated Stress Index score number is used to determine the crop health. In another embodiment, the stress index score is further divided into discrete levels, such as, for example:

−100=no stress (normal growth);
−100 to −70=normal stress;
−70 to 0=high stress; and
0 and above=extreme stress.

This stress index can be adjusted as needed, such as according to each crop, stage of crop growth, and crop sensitivity to temperature stress.

Turning to the figures, the top half of FIG. 1 depicts a line graph showing an example crop's temperature fluctuations over a 16 day period when the crop is given 0.10 inches per day of irrigation. The line graph illustrates a given optimum canopy temperature of 82° F., which is the optimum temperature for cotton. Plotted with this optimum are collected ambient temperatures and crop canopy temperatures, showing where the crop canopy temperature exceeded the optimum for any given day. The crop canopy temperature is shown in gray while the ambient temperature in shown in black. This information can be made available to the grower via a website or other internet based system, if desired.

The lower half of FIG. 1 is a bar graph reflecting not only when the crop canopy temperature was above optimum, but also a representation of triggers indicating when the plant experienced a high or extreme stress level. This helps the grower better understand how or if the exposure to higher temperature actually impacted the plant. The FIG. 1 bar graph differentiates stairsteps of four different levels of stress: normal growth (at optimal temperature), normal stress level, high stress level and extreme stress level. As an example, when expressed in relation to a cotton plant having an optimum temperature of 82° F., a stress level point may be triggered when the plant experiences canopy temperatures in excess of 82° F. The grower may or may not wish to react at that point. In some embodiments, a high stress level point may be triggered when the plant experiences canopy temperatures in excess of 30° C. (86° F.) and an extreme stress level point may be triggered when the plant experiences canopy temperatures in excess of 33° C. (91° F.).

In some embodiments, the grower may have predetermined that based on studies of effect on yield and other variables he wishes to intervene only when the plant is experiencing high or extreme stress levels, as opposed to normal stress levels. The disclosed method and system enables him to, in real time, determine whether the plant is at a stress level that triggers a management decision.

FIG. 2 illustrates an even more sophisticated data collection and assessment. In FIG. 2, which represents the same crop as in FIG. 1, which received 0.10 inches of irrigation per day, not only are the ranges of temperatures in excess of the optimum considered, but also the length of time the plant was experiencing stress. In FIG. 2, the length of time the plant was above optimum temperature during a 24 hour period is multiplied by the average of the temperatures collected above optimum. The plant's canopy temperature can be collected as often as desired. In an embodiment, a reading is taken every minute. In some embodiments, the average temperature above optimum is calculated by fifteen minute slices of data over a 24 hour period. Over the fifteen minutes, if the plant averaged three degrees above optimum temperature, then 15 is multiplied by 3 rendering a stress factor of 45. As an example, the FIG. 2 bar graph for August 15th rendered a total score of 2400 units over a 24 hour period. The grower can then determine at what unit number (or “trigger”) he wishes to initiate a response. The disclosed invention provides a series of progressively more critical triggers. The grower can then determine at what trigger point to intervene. For cotton grown in west Texas, for example, it appears that daily accumulations of 600 to 800 units of accumulated area provides an optimum result of yield and water efficiency.

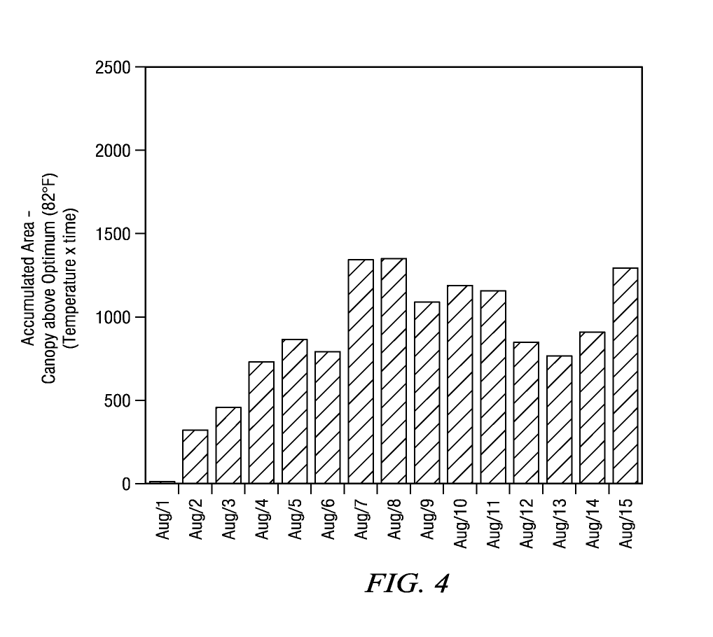

FIG. 3 and FIG. 4 are similar to FIG. 1 and FIG. 2, except that FIG. 3 and FIG. 4 reflect the crop's temperature fluctuations and stress ranges when irrigated with 0.12 inches of water per day.

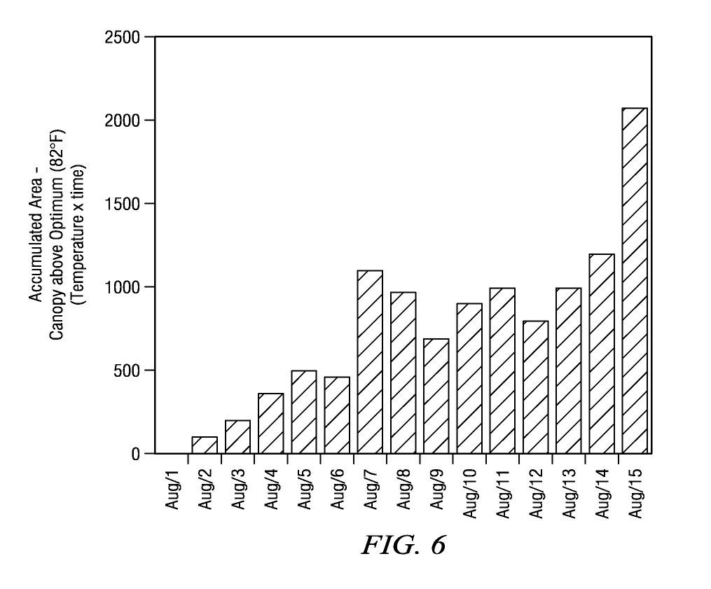

FIG. 5 and FIG. 6 are similar to FIG. 1 and FIG. 2, except that FIG. 5 and FIG. 6 reflect the crop's temperature fluctuations and stress ranges when irrigated with 0.20 inches of water per day.

In some embodiments, the disclosed method and apparatus puts objective data in the hands of the grower so that the grower can effectively measure crop health, irrigation needs, crop status and predict crop yield, while making informed management decisions. The disclosed method and apparatus gives the grower triggers that indicate when a management decision or action is prudent versus when such an intervention may not make a profound difference in ultimate crop yield or desired crop characteristics.

### Data Analysis Method 3): “Accumulated Area” Stress Count

In a third data analysis method, the observed canopy temperature is plotted throughout the day, and compared to the known optimal temperature for the crop. The amount of time that the crop is above the optimal temperature, multiplied by the degrees above the optimal temperature (thus, the “area under the curve”) is determined at intervals throughout the day, and this data is accumulated throughout the day. When the accumulated area stress count reaches a certain pre-determined number, a trigger for an alert can be sent out to irrigate the crop.

Table II is a tabulation illustrating the types of calculations that were utilized for FIG. 1 through FIG. 6. The table shows the details of the data obtained every 15 minutes in a 24 hour period for the crop shown in FIG. 1 and FIG. 2, which was watered at 0.1 inches per day. Columns 4-6 list the observed canopy temperature, optimal (“threshold”) temperature, and the temperature difference (all in ° C.). Column 7 lists the area under the curve (but above the optimal canopy temperature), which was determined by multiplying the 15 minute period by the temperature (in ° C.) above the optimal temperature. Column 8, last row, displays the accumulated total score of the area under the curve measurements (column 7) for the given day.

TABLE II
Accumulated Area Calculations. An example calculation of the area for
August 4 for a .10 in water treatment:

| | Time | Treatment | Canopy | Threshold | Difference | Area |
|---|---|---|---|---|---|---|
| Date | Min. | ° C. | ° C. | ° C. | ° C. | ° C. min |
| Aug. 4, 2009 | 0:00:00 | 0.10 | 21.775 | 28 | −6.225 | 0 |
| Aug. 4, 2009 | 0:15:00 | 0.10 | 21.675 | 28 | −6.325 | 0 |
| Aug. 4, 2009 | 0:30:00 | 0.10 | 20.685 | 28 | −7.315 | 0 |
| Aug. 4, 2009 | 0:45:00 | 0.10 | 19.545 | 28 | −8.455 | 0 |
| Aug. 4, 2009 | 1:00:00 | 0.10 | 19.57 | 28 | −8.43 | 0 |
| Aug. 4, 2009 | 1:15:00 | 0.10 | 19.99 | 28 | −8.01 | 0 |
| Aug. 4, 2009 | 1:30:00 | 0.10 | 19.19 | 28 | −8.81 | 0 |
| Aug. 4, 2009 | 1:45:00 | 0.10 | 19.19 | 28 | −8.81 | 0 |
| Aug. 4, 2009 | 2:00:00 | 0.10 | 18.975 | 28 | −9.025 | 0 |
| Aug. 4, 2009 | 2:15:00 | 0.10 | 19.795 | 28 | −8.205 | 0 |
| Aug. 4, 2009 | 2:30:00 | 0.10 | 20.535 | 28 | −7.465 | 0 |
| Aug. 4, 2009 | 2:45:00 | 0.10 | 19.595 | 28 | −8.405 | 0 |
| Aug. 4, 2009 | 3:00:00 | 0.10 | 19.005 | 28 | −8.995 | 0 |
| Aug. 4, 2009 | 3:15:00 | 0.10 | 19.3 | 28 | −8.7 | 0 |
| Aug. 4, 2009 | 3:30:00 | 0.10 | 20.95 | 28 | −7.05 | 0 |
| Aug. 4, 2009 | 3:45:00 | 0.10 | 21.465 | 28 | −6.535 | 0 |
| Aug. 4, 2009 | 4:00:00 | 0.10 | 21.38 | 28 | −6.62 | 0 |
| Aug. 4, 2009 | 4:15:00 | 0.10 | 20.935 | 28 | −7.065 | 0 |
| Aug. 4, 2009 | 4:30:00 | 0.10 | 20.575 | 28 | −7.425 | 0 |
| Aug. 4, 2009 | 4:45:00 | 0.10 | 21.315 | 28 | −6.685 | 0 |
| Aug. 4, 2009 | 5:00:00 | 0.10 | 21.025 | 28 | −6.975 | 0 |
| Aug. 4, 2009 | 5:15:00 | 0.10 | 20.635 | 28 | −7.365 | 0 |
| Aug. 4, 2009 | 5:30:00 | 0.10 | 20.435 | 28 | −7.565 | 0 |
| Aug. 4, 2009 | 5:45:00 | 0.10 | 20.6 | 28 | −7.4 | 0 |
| Aug. 4, 2009 | 6:00:00 | 0.10 | 20.62 | 28 | −7.38 | 0 |
| Aug. 4, 2009 | 6:15:00 | 0.10 | 20.52 | 28 | −7.48 | 0 |
| Aug. 4, 2009 | 6:30:00 | 0.10 | 20.38 | 28 | −7.62 | 0 |
| Aug. 4, 2009 | 6:45:00 | 0.10 | 20.115 | 28 | −7.885 | 0 |
| Aug. 4, 2009 | 7:00:00 | 0.10 | 19.665 | 28 | −8.335 | 0 |
| Aug. 4, 2009 | 7:15:00 | 0.10 | 19.495 | 28 | −8.505 | 0 |
| Aug. 4, 2009 | 7:30:00 | 0.10 | 19.61 | 28 | −8.39 | 0 |
| Aug. 4, 2009 | 7:45:00 | 0.10 | 19.545 | 28 | −8.455 | 0 |
| Aug. 4, 2009 | 8:00:00 | 0.10 | 19.61 | 28 | −8.39 | 0 |
| Aug. 4, 2009 | 8:15:00 | 0.10 | 19.97 | 28 | −8.03 | 0 |
| Aug. 4, 2009 | 8:30:00 | 0.10 | 20.05 | 28 | −7.95 | 0 |
| Aug. 4, 2009 | 8:45:00 | 0.10 | 21.005 | 28 | −6.995 | 0 |
| Aug. 4, 2009 | 9:00:00 | 0.10 | 21.59 | 28 | −6.41 | 0 |
| Aug. 4, 2009 | 9:15:00 | 0.10 | 22.34 | 28 | −5.66 | 0 |
| Aug. 4, 2009 | 9:30:00 | 0.10 | 23.035 | 28 | −4.965 | 0 |
| Aug. 4, 2009 | 9:45:00 | 0.10 | 23.88 | 28 | −4.12 | 0 |
| Aug. 4, 2009 | 10:00:00 | 0.10 | 24.625 | 28 | −3.375 | 0 |
| Aug. 4, 2009 | 10:15:00 | 0.10 | 24.91 | 28 | −3.09 | 0 |
| Aug. 4, 2009 | 10:30:00 | 0.10 | 25.25 | 28 | −2.75 | 0 |
| Aug. 4, 2009 | 10:45:00 | 0.10 | 26.16 | 28 | −1.84 | 0 |
| Aug. 4, 2009 | 11:00:00 | 0.10 | 26.48 | 28 | −1.52 | 0 |
| Aug. 4, 2009 | 11:15:00 | 0.10 | 27.045 | 28 | −0.955 | 0 |
| Aug. 4, 2009 | 11:30:00 | 0.10 | 27.655 | 28 | −0.345 | 0 |
| Aug. 4, 2009 | 11:45:00 | 0.10 | 28.125 | 28 | 0.125 | 1.875 |
| Aug. 4, 2009 | 12:00:00 | 0.10 | 28.9 | 28 | 0.9 | 13.5 |
| Aug. 4, 2009 | 12:15:00 | 0.10 | 29.53 | 28 | 1.53 | 22.95 |
| Aug. 4, 2009 | 12:30:00 | 0.10 | 14.96 | 28 | −13.04 | 0 |
| Aug. 4, 2009 | 12:45:00 | 0.10 | 30.13 | 28 | 2.13 | 31.95 |
| Aug. 4, 2009 | 13:00:00 | 0.10 | 30.52 | 28 | 2.52 | 37.8 |
| Aug. 4, 2009 | 13:15:00 | 0.10 | 30.905 | 28 | 2.905 | 43.575 |
| Aug. 4, 2009 | 13:30:00 | 0.10 | 30.96 | 28 | 2.96 | 44.4 |
| Aug. 4, 2009 | 13:45:00 | 0.10 | 31.325 | 28 | 3.325 | 49.875 |
| Aug. 4, 2009 | 14:00:00 | 0.10 | 31.1 | 28 | 3.1 | 46.5 |
| Aug. 4, 2009 | 14:15:00 | 0.10 | 31.49 | 28 | 3.49 | 52.35 |
| Aug. 4, 2009 | 14:30:00 | 0.10 | 31.515 | 28 | 3.515 | 52.725 |
| Aug. 4, 2009 | 14:45:00 | 0.10 | 31.97 | 28 | 3.97 | 59.55 |
| Aug. 4, 2009 | 15:00:00 | 0.10 | 32.29 | 28 | 4.29 | 64.35 |
| Aug. 4, 2009 | 15:15:00 | 0.10 | 32.53 | 28 | 4.53 | 67.95 |
| Aug. 4, 2009 | 15:30:00 | 0.10 | 32.58 | 28 | 4.58 | 68.7 |
| Aug. 4, 2009 | 15:45:00 | 0.10 | 32.81 | 28 | 4.81 | 72.15 |
| Aug. 4, 2009 | 16:00:00 | 0.10 | 32.805 | 28 | 4.805 | 72.075 |
| Aug. 4, 2009 | 16:15:00 | 0.10 | 32.46 | 28 | 4.46 | 66.9 |
| Aug. 4, 2009 | 16:30:00 | 0.10 | 32.32 | 28 | 4.32 | 64.8 |
| Aug. 4, 2009 | 16:45:00 | 0.10 | 32.105 | 28 | 4.105 | 61.575 |
| Aug. 4, 2009 | 17:00:00 | 0.10 | 31.815 | 28 | 3.815 | 57.225 |
| Aug. 4, 2009 | 17:15:00 | 0.10 | 31.485 | 28 | 3.485 | 52.275 |
| Aug. 4, 2009 | 17:30:00 | 0.10 | 31.15 | 28 | 3.15 | 47.25 |
| Aug. 4, 2009 | 17:45:00 | 0.10 | 30.83 | 28 | 2.83 | 42.45 |
| Aug. 4, 2009 | 18:00:00 | 0.10 | 30.64 | 28 | 2.64 | 39.6 |
| Aug. 4, 2009 | 18:15:00 | 0.10 | 30.355 | 28 | 2.355 | 35.325 |
| Aug. 4, 2009 | 18:30:00 | 0.10 | 30.07 | 28 | 2.07 | 31.05 |
| Aug. 4, 2009 | 18:45:00 | 0.10 | 29.965 | 28 | 1.965 | 29.475 |
| Aug. 4, 2009 | 19:00:00 | 0.10 | 29.725 | 28 | 1.725 | 25.875 |
| Aug. 4, 2009 | 19:15:00 | 0.10 | 29.54 | 28 | 1.54 | 23.1 |
| Aug. 4, 2009 | 19:30:00 | 0.10 | 29.55 | 28 | 1.55 | 23.25 |
| Aug. 4, 2009 | 19:45:00 | 0.10 | 29.115 | 28 | 1.115 | 16.725 |
| Aug. 4, 2009 | 20:00:00 | 0.10 | 28.87 | 28 | 0.87 | 13.05 |
| Aug. 4, 2009 | 20:15:00 | 0.10 | 28.535 | 28 | 0.535 | 8.025 |
| Aug. 4, 2009 | 20:30:00 | 0.10 | 28.4 | 28 | 0.4 | 6 |
| Aug. 4, 2009 | 20:45:00 | 0.10 | 27.555 | 28 | −0.445 | 0 |
| Aug. 4, 2009 | 21:00:00 | 0.10 | 27.005 | 28 | −0.995 | 0 |
| Aug. 4, 2009 | 21:15:00 | 0.10 | 26.18 | 28 | −1.82 | 0 |
| Aug. 4, 2009 | 21:30:00 | 0.10 | 25.645 | 28 | −2.355 | 0 |
| Aug. 4, 2009 | 21:45:00 | 0.10 | 25.005 | 28 | −2.995 | 0 |
| Aug. 4, 2009 | 22:00:00 | 0.10 | 23.61 | 28 | −4.39 | 0 |
| Aug. 4, 2009 | 22:15:00 | 0.10 | 23.52 | 28 | −4.48 | 0 |
| Aug. 4, 2009 | 22:30:00 | 0.10 | 23.24 | 28 | −4.76 | 0 |
| Aug. 4, 2009 | 22:45:00 | 0.10 | 22.055 | 28 | −5.945 | 0 |
| Aug. 4, 2009 | 23:00:00 | 0.10 | 22.57 | 28 | −5.43 | 0 |
| Aug. 4, 2009 | 23:15:00 | 0.10 | 23.585 | 28 | −4.415 | 0 |
| Aug. 4, 2009 | 23:30:00 | 0.10 | 23.455 | 28 | −4.545 | 0 |
| Aug. 4, 2009 | 23:45:00 | 0.10 | 21.985 | 28 | −6.015 | 0 |

Accumulated Area = 1446.225

As shown in Table II, this method can be used to alert the need for a crop management decision. The table data shows cotton canopy temperatures taken every 15 minutes, over a 24 hour period from a crop receiving 0.10 inches of water per day (as shown in FIG. 1). Cotton has an optimum canopy temperature of 28° C., therefore the plant is experiencing some amount of temperature stress when the canopy is at any temperature above 28° C. The Reimann summation method is utilized to essentially calculate the area under the canopy temperature curve and above the 28° C. threshold. In order to calculate the area, 28° C. is subtracted from the canopy temperature, yielding the amount by which the canopy exceeds the optimum temperature (shown in Table II in the column entitled “Difference”). Since, in one embodiment, the data for the canopy temperature is available in 15-minute intervals, the difference between the canopy temperature and 28° C. is multiplied by 15 minutes for each interval that exceeds 28° C. If the difference is less than or equal to 0, the area is recorded as 0 (as shown in Table II in the column entitled “Area”). At the end of each day, the total accumulated area is calculated by adding all areas above 0 (as shown in Table II in the last row of the column entitled “Accumulated Area”). This value is then plotted on a bar graph to show the accumulated area for each day. Table II reflects an example calculation of the area for August 4th for a 0.10 inch water treatment. The accumulated area total found on the last line of Table II is 1446.225, which is plotted in the bar graph of FIG. 2. This value is a measure of the accumulated amount of stress the crop has been subjected to over the course of that day. The grower may then take this figure into account in addition to other variables such as the market, energy costs or other variables before determining whether to take action. He may customize his growing plan such that he only intervenes with irrigation if the daily accumulated area total is above the trigger level of 1500, as an example. The system may also be configured to alert the grower when the accumulated area for a particular day exceeds a pre-selected threshold.

In some embodiments, the grower can set the system so that a trigger occurs when a certain total score for the “accumulated area” is reached, but within an hour or a shorter time if the “extreme stress” temperature group is reached. For example, a daily accumulation trigger level of from less than or about 1,000, or about 1,200, about 1,300, about 1,400, to about 1,500, about 1,600, about 1,700, 1,800, 2,000, 2,200, 2,400, 2,600, 2,800, 3,000, 3,200, 3,400, 3,600, 3,800, 4,000, or more can be set so that an alert can be sent when the crop reaches the set number.

In some embodiments, the trigger for alerting the grower is determined from the accumulated stress count, measured over an hour, or a day, or a week, or even during the entire season of the crop. In certain embodiments, the accumulated stress score over the entire life of the plant can be used.

### Setting the Trigger Level by Use of Various Data Analysis Methods

In some embodiments, the grower can be alerted so that he can manually initiate irrigation, either remotely or at the crop location. In some embodiments, the irrigation decision is made automatically, generated from the algorithms of the accumulated temperature and/or time above optimal temperature, as described herein.

In some embodiments, such as when growing a very temperature sensitive plant, or a plant that is in a sensitive stage of its life cycle, the system can be set so that a very low Reimann sum, or a very low amount of time above optimal temperature, is set as a trigger for an irrigation alert.

In some embodiments, the critical temperature for a specific plant type can be determined empirically, or can be predicted, based on knowledge from other plant species, or can be downloaded from a database.

In some embodiments, the grower can base a “trigger” for an alert on predicted yield. For example, if a planned amount of daily irrigation will result in 95 to 100% predicted yield, the grower may wish to set the trigger of 80% yield, so that he is alerted when watering is necessary to prevent a yield that is any lower than the 80% amount. Similarly, a grower can set the trigger for irrigation so that the crop doesn't get below 85%, 75% 70%, 65%, 60%, 55%, 50%, 45% or 40% predicted yield.

Additionally, in some embodiments, the methods described herein can be used to select for and further characterize optimal plant genetic varieties for growth in certain temperature regimes or in certain water availability regimes. In some embodiments, the method can be used to examine the effects of the introduction of a transgenic sequence or a mutation on plant stress and yield. In some embodiments, the method can be used to examine or characterize the temperature stress responses of progeny from a controlled breeding program. The method can also be used to compare two or more cultivars to determine physiological differences in their response to temperature stress.

### Irrigation

When the alert for a management decision results in the initiation of irrigation, any suitable irrigation means can be used. In one embodiment, the crop is irrigated at a certain pre-determined level per day or week. The trigger alert system is set up for the possibility of the need for additional watering of the crop. In another embodiment, the crop is not automatically watered on a set cycle; instead, the irrigation is initiated only when an alert is sent out.

The irrigation can be controlled, for example, manually, automatically, by remote control, or by other means. The irrigation can be set, for example, as a daily or weekly cycle. The irrigation method can be, for example, drip irrigation, center pivot irrigation, linear move (pivot) irrigation, lateral move irrigation, overhead irrigation, manual irrigation, sprinkler system, a rotary system, or subirrigation. Combinations of irrigation methods can be used.

### Irrigation Districts

In an embodiment, the results of the data analysis, such as the irrigation usage, crop canopy temperatures, accumulated stress count, Smartfield stress index, discrete temperature ratings (normal stress, high stress, extreme stress), yields, crop plant stress assessments, and other information can be designed to be accessible by entities or groups including, but not limited to, a specialized water management organization, a government agency, the public, an organization of farmers, an irrigation district, a water district, an association of water users, and the like. In some situations, this gives the grower transparency in the community, so that he is able to demonstrate that he is not wasting water in order to grow his crops. In regions of low water availability, where many types of users may be competing for the same limited water resources, the ability of the grower to clearly demonstrate that he is not wasting water can be an important asset.

Correlation of Temperature Stress with Yield

When comparing FIG. 1 through FIG. 7, it becomes clear that providing the crop with higher amounts of irrigation resulted in more stable levels of stress experienced by the crop. The example crop receiving only 0.10 inches of daily irrigation experienced significantly more cumulative stress, and higher levels of stress, than crops that received 0.20 inches of daily irrigation.

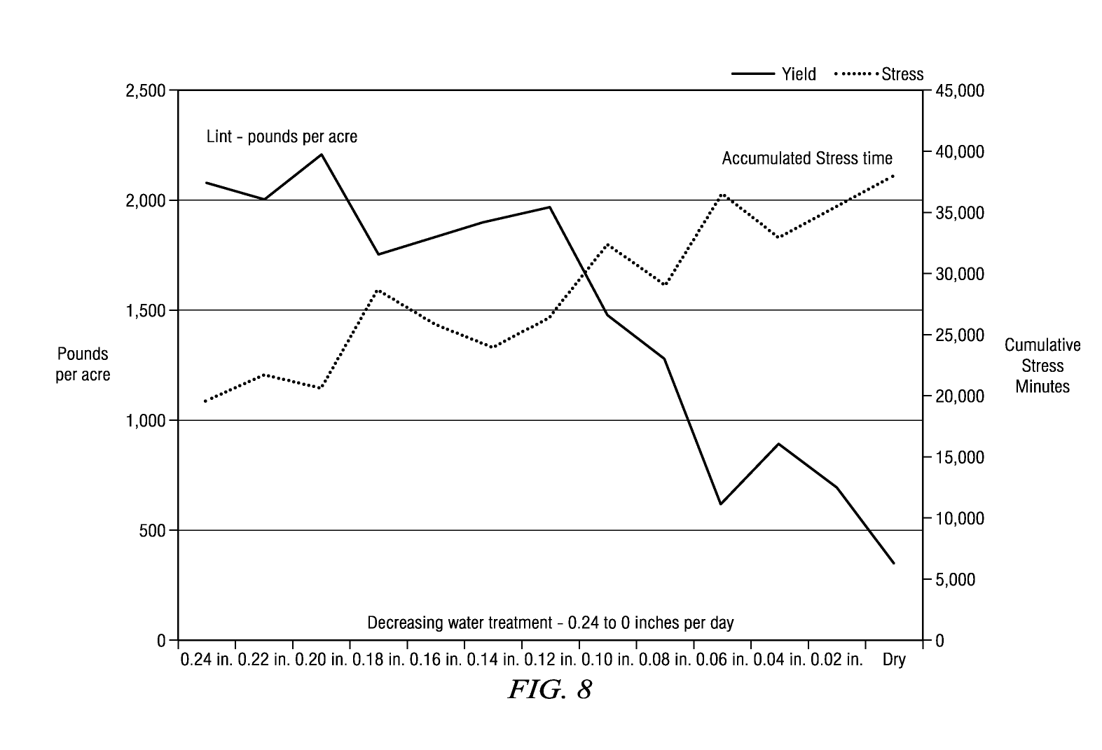

FIG. 8 reveals in more detail how crops that experienced less stress ultimately had higher yields. FIG. 8 shows cotton data from west Texas in 2009, demonstrating how yield is correlated to stress. As the line graphs demonstrate, the increase in accumulated stress time results in a plunging yield. In an embodiment, a grower using the disclosed method and system can track this information over multiple growing seasons and plot whether the expenditures related to the extra water resulted in enough additional yield to warrant the higher costs.

### Programming the Trigger for an Alert for a Certain Predicted Yield of a Crop

In some embodiments, the data analysis methods can include estimates of predicted yield of a crop under certain water deficit conditions. For example, in addition to data analysis based on the observed and optimal leaf temperature, the grower can factor in the predicted yield that would be obtained at certain irrigation levels. For example, the grower can factor in the amount of water he would need to reach a predicted yield level of 50%, 60%, 70%, 80%, 90%, 95%, 98%, or 100% of optimal yield, using any suitable means, such as, for example, available databases, agricultural literature, and his own empirical knowledge of his crop.

The system is set up so that, in years where the water availability is higher, he can change the trigger setting to send an alert when the predicted yield falls below 90%, 95%, 95%, etc., unless irrigation is initiated immediately. Similarly, in seasons of extreme drought in the region, where household needs may become more important than agricultural needs, the grower can set the trigger so that he is alerted only when the predicted yield would go below 50%, or 60%, if he does not water immediately.

In some embodiments, the disclosed method and apparatus reflects a way for growers to be alerted to trigger points based on the level of stress and the time under stress experienced by a crop. Utilizing the disclosed invention, the grower can choose what triggers to take action on, enabling more customization of crop management. As an example, he may wish to make different management decisions based on different triggers, and even based on external circumstances such as, for example, the cost of water, the cost of oil or electricity, the weather, changes in stock prices, changes in transportation costs, changes in crop prices, and the like.

### System for Monitoring Crops

In one embodiment, automated systems for monitoring crop conditions and/or making irrigation decisions known in the art could be modified to perform the methods described above. One such system is described in PCT publication WO 2010/117944, Remote Analysis and Correction of Crop Conditions, which is incorporated by reference.

In one embodiment, the disclosed invention provides a relatively simple and inexpensive method and system for real time automatically and remotely assessing and evaluating crop condition and responding with a management decision. In one embodiment, the method incorporates wired and wireless transmission to collect and transmit the data. In one embodiment, the end user benefits by receiving crop alerts and computerized management decisions on the time interval of his choice. He may choose to execute control commands himself or just receive alerts that changes have been made by the field based controller.

In one embodiment infrared thermometers, plant leaf wetness sensors, leaf thickness sensors and/or dendrometers allow researchers and growers the opportunity to measure more objective and relevant plant characteristics, yet do so remotely by placing such sensors in the field and equipping them with radio chips or other means for data transmission back to a controller.

In some embodiments, the disclosed method and system is able to correlate a one or more variables with known plant parameters, in addition to the determine of stress by monitoring temperature, to determine exactly what a plant's water requirements or other needs are.

As an example, the following characteristics can be collected and analyzed to reach the final irrigation decision. Crop biological characteristics which could be collected include canopy temperature, leaf wetness, stem diameter, leaf thickness, and canopy color. Weather characteristics which may be collected include solar radiation, humidity, ambient temperature, barometric pressure and wind speed.

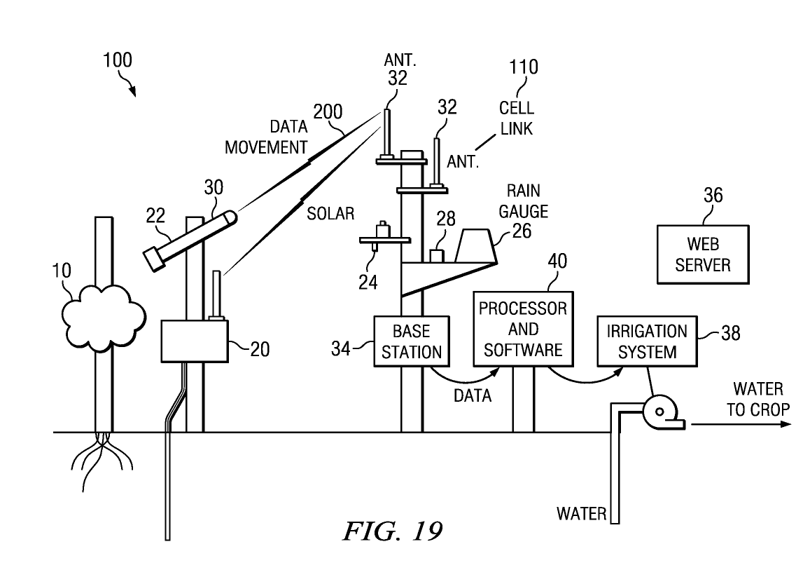

Turning to the figures for illustration, in FIG. 19 is depicted a schematic overview of an embodiment 100 of the method and system. Placed in the crop 10 at desired intervals are a variety of crop sensors which may include, as depicted, a soil moisture sensor 20, or a canopy temperature sensor 22. Also placed in the field, or hardwired to the field base station, are sensors to measure weather characteristics, which may include a solar radiation sensor 24, a rain gauge 26 and a barometric pressure gauge 28. The types of crop sensors used may vary according to the type of crop and the crop characteristics which the grower wishes to measure. Examples of other sensors that may be placed could include sensors or gauges to measure leaf thickness, leaf wetness, wind speed and direction or ambient temperature.

The sensors, for example the canopy temperature sensor 22, may be programmed to take readings on whatever schedule is desired by the grower. In one embodiment, small, lightweight, inexpensive infrared sensors are used. Canopy temperature sensors 22, when used, are placed at a reasonable height to be able to measure the tops, or canopy, of the leaves, depending on the height of the plant. The sensors may be powered by batteries or solar power. The sensors used in the one embodiment have the capability to take readings as frequently as every five seconds. In one embodiment the sensor takes a reading every sixty seconds and hibernates between readings to conserve battery life. In one embodiment, the time interval can be changed with switch settings in the sensor electronics or by software changes. In one embodiment using the sixty second interval, the batteries have been found to last eight to nine months.

In one embodiment, the crop canopy temperature sensors 22 have a built in radio transceiver 30. The readings are transmitted via radio frequency 200 to an antenna 32 located on the field base station 34. At a specified time interval, the crop canopy temperature sensor 22 (or other type of sensor) takes an average of its last several readings and transmits the average to the field base station 34. The field base station 34 can be a receiver (for one way transmission) or may be a transceiver (for two way transmission). In one embodiment, the sensor 22 averages its readings every 15 minutes and transmitted the average.

In one embodiment, the environmental characteristics such as relative humidity, rainfall and air temperature can be measured in the field by sensors or by pods that are hardwired to the field base station. Additional environmental data to assist with weather projections can also be collected and may include barometric pressure or other weather related readings. In another embodiment, environmental data can be supplied from a sourse external to the system, such as a weather report being supplied from the internet or other computer database.

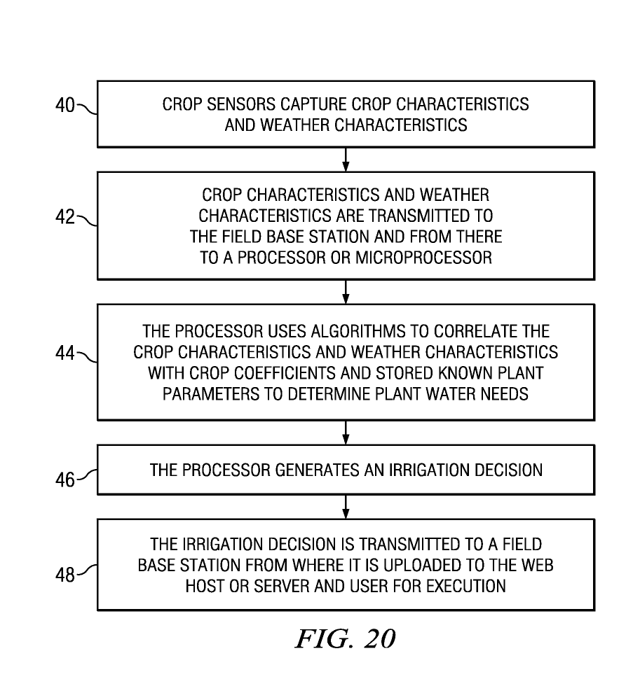

FIG. 20 depicts a flowchart of an embodiment 400 of the disclosed method and system. In the first step 40, the crop sensors capture the crop characteristics and weather characteristics, as earlier described. In the second step 42, the crop characteristics and weather characteristics are transmitted to the field base station and from there to a processor. In step three 44, the processor uses stored algorithms to correlate the crop characteristics and possibly weather characteristics with crop coefficients and/or stored known plant parameters to determine a stress-related need. In step four 46, the processor calculates and generates an irrigation decision. In step five 48, the irrigation decision is transmitted to the field base station 34 from where it is uploaded to the web host or server 36 and transmitted to the end user for execution. The management decision may be manually, automatically or remotely executed, or a report may be generated.

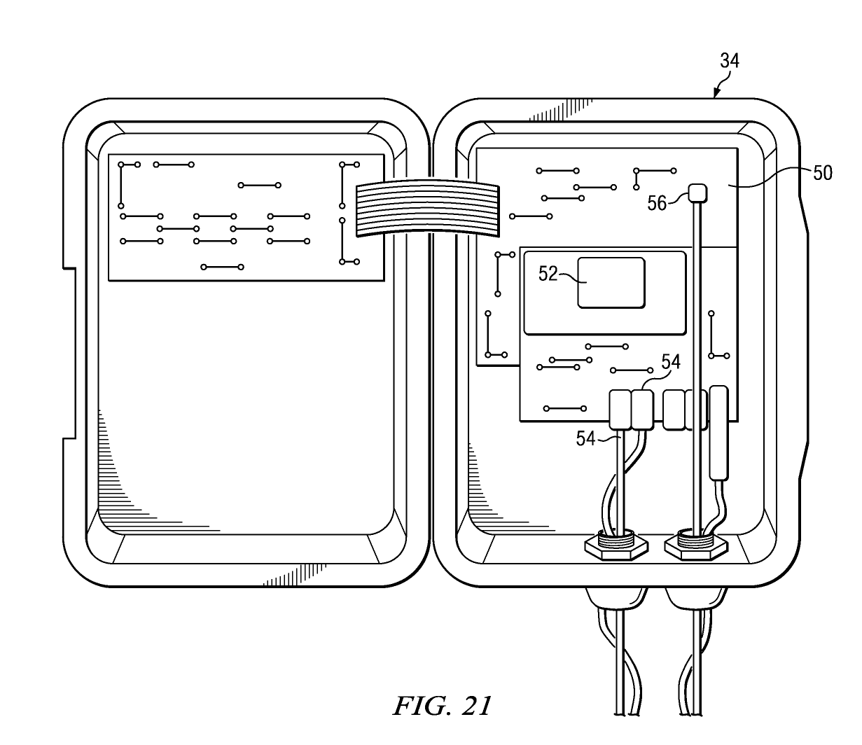

In the embodiment shown in FIG. 21, the field base station 34 contains a motherboard 50, a modem 52, a communications cable 56, and is programmed with a specific IP address. In a one embodiment, at various time intervals, for example every two hours, a remote central computer with a processor or microprocessor and a memory calls the modem 52 and uploads the collected data for storage and processing. The central computer can upload the data to a web host or server 36. The web server 36 can store the data, for reference by the grower. Hardwired into the bottom of the field base station are the weather characteristic sensors, for example the wiring 54 for the rain gauge 26 or others.

Since the field base station 34 has its own IP address, it can be contacted at any time remotely using an internet enabled device. For example, the grower could, from the comfort of his home, access the data in the field base station. In one embodiment, the field base station 34 is also capable of a WiFi connection. In one embodiment, the user may to go out to the field at times and use a data cable to connect their cell phone, PDA or laptop directly to the field base station and access and store readings. In one embodiment, the central computer may be programmed to post status alerts to the website, and/or transmit the message to the end user via cell phone text message, email or other known methods. The end user might receive a message such as the following: “Your crops are currently not in water stress. 0.52” of rainfall has been reported at the site. The method has issued a stop irrigation command. The irrigation is currently off. The method will advise when to resume irrigation.”

As noted in the message above, the central computer can, in one embodiment, simultaneously with the transmission of the message to the end user, also send a control command to the field base station. In one embodiment, the field base station 34 is wired into the irrigation system control panel 38 and can initiate, stop or adjust irrigation schedules as indicated by the control command.

In one embodiment, the grower is able to visit the web server 36 to view the historical data that was collected and used as the basis for the watering decision. He can analyze trends as desired. In one embodiment, the grower can override any decision made by the computer algorithms by manually resetting his irrigation or topical application, or resetting the control panel or choosing specific options on the website. In one embodiment, the method is programmed to transmit any type of relevant management information. For example, the grower may wish to incorporate data pertaining to soil moisture, soil nutrient content, pressure changes of the irrigation method, or other data that a grower would routinely check when visiting the field. In one embodiment, if so programmed, sensors or pods would be placed in the field to relay such data to the field base station 34 for transmission to the central computer and upload to the web server 36. In some embodiments, the grower can check comprehensive parameters and conditions of his crop from various remote locations and can simultaneously send control commands back to the field based controller.

In one embodiment, the central computer is programmed with software containing one or more known plant parameters for biologic characteristics that would be useful in determining whether the plant is stressed. The computer may also be programmed with various known algorithms to calculate plant water needs based on the plant species and stage of growth. In one embodiment, the data is correlated with the algorithms to reach watering decisions using a software program such as SmartDrip™ 40.

As an example, one algorithm developed by the inventors is as follows:

Irrigation decision (<0=NO:>0=YES)=a(Plant stress time)+b(Canopy temp−optimum temp)+c(sensor input)+d(soil moisture content)+e(cost of water)+f(crop price)+g(water remaining)+h(predicted future high temps)+i(desired yield percentage)+j(desire margin percentage)+k(cost of energy)

The crop coefficients “a” through “k” listed above are specific to crop, growing location, and soil conditions which can be input by the user.

Market conditions and weather forecasts may be crop coefficients as well. To determine whether or not to irrigate is a complicated matter made up of numerous inputs. This equation deals with those inputs by creating a factoring of all inputs to determine a YES or NO irrigation decision. The period of this determination can be varied depending on the physical limitations of the irrigation system. The equation compiles information about the health of the crop, the water status in the soil and the economics of the irrigation decision in regards to input.

The end user may enter data pertaining to the plant's life stage or other variables to assist the computer with its decision. In one embodiment, the application will employ multiple streams of data, including the factors of average stress time for the previous day, or some number of days, measurements regarding the output of the irrigation systems, both time and volume, and predictive factors based on expected weather data, such as forecasted high temperature for the upcoming day, or days to reach its irrigation decision. In some embodiments, the computer software generates an irrigation decision to stop, start or adjust irrigation based on the data, algorithms and predetermined parameters.

In one embodiment, the apparatus will employ three modes of operation: Timer mode, Hybrid mode and Automatic Mode. In one embodiment, in the Timer Mode, the operator can turn irrigation system ON or OFF based on a typical schedule controller. This option can have remote control via Internet connection, but it does not take any input from biological sensors and considers time only control. This mode would be similar to a typical irrigation controller although the currently known controllers lack the remote access via Internet connection disclosed herein.

In one embodiment, in the Automatic Mode the apparatus will use biological and environmental information supplied by Smartfield™ systems (SmartCrop™, SmartWeather™, SmartProfile™ 3X, Sensor Station and others) to schedule irrigation automatically based on the plant's needs and the measured environmental variables, such as ambient temperature or solar radiation. In the automatic mode, each irrigation zone would be activated to run for a period of time calculated off a crop value (for example, the amount of accumulated stress for that particular crop). This value is used in an algorithm to translate the metric into a reasonable time period as shown below. Because the value is based on the plant canopy temperature, any control logic is self-correcting in that if too little water is applied during the Automatic Mode, the subsequent measurement of time of canopy temperature above biological optimum will be a greater number, which will increase the amount of irrigation time for the next period.

In one embodiment, in the Hybrid Mode, the apparatus splits an irrigation interval (for example 24 hours) into two periods. One period would be a Timer Mode and the other period would be Automatic Mode.

Irrigation Timing Algorithms:

Automatic Irrigation Time per zone (T_{AI(1)}): T_{AI(1)}=Stress Time*Irrigation Factor

Given a Stress Time of 210 minutes for zone 1 and an Irrigation Factor of 3.33;
T_{AI(1)}=63 minutes

An additional logical algorithm can be added to automatically adjust the Irrigation Factor to make it self-correcting such that irrigation times that continue to increase while daily high temperatures are not increasing suggests that the irrigation times are set too low. Likewise, if irrigation times are decreasing while daily high temperatures are increasing suggests that irrigation times are set too high. Therefore, the following equation allows for the automatic correction of irrigation times by the adjustment of the Irrigation Factor (IF): Irrigation Factor (New): IFNEW=IF0+TF0/TF(−5)

Where:

IF₀=Irrigation Factor at today

TF=Time Factor=3-day high temp average/3-day Irrigation Time average

TF₀=Time Factor at today

TF₍₋₅₎=Time Factor five days ago

If: IF₀=3.33

TF₀=64.58

TF₍₋₅₎=60.42

Then: IF_{NEW}=3.56

Additionally, a minimum and maximum time per irrigation interval can be used to adjust the Irrigation Factor. For instance, if a minimum irrigation time per day of 20 hours is desired and a maximum irrigation time per day of 23 hours is also desired, then irrigation times can be calculated with the current Irrigation Factor and if the total irrigation times for all zones added together is not within the min/max range, the Irrigation Factor can be altered by the correct percentage to reach a min/max point.

The computerized nature of the entire system lends itself to a plethora of customization options. One example is the Varying Zonal Irrigation schedule: In one embodiment, the SmartDrip™ controller can be set to select the zone with the highest automatic irrigation time to be the one that is irrigated first, the zone with the second highest automatic irrigation time to the irrigated second and so on until all zones have been irrigated.

In another embodiment, the system can vary irrigation by weather forecast. To do so an additional adjustment is made to the automatic irrigation time by allowing a modification based on multiplying the automatic irrigation time by a factor based on forecasted high temperature, the higher the forecasted high temperature, the greater the factor, the cooler the forecasted high temperature, the lesser the factor. The factor should be set to a minimum range of approximately 0.9 and a maximum range of 1.1. Also, the forecasted high temperature adjustment can be made on a three or five day forecast as well as a single day forecast.

Turning back to FIG. 19, in one embodiment, once the central computer has correlated the collected data with the algorithms and parameters, the computer formulates a YES or NO decision whether to irrigate, or apply a topical application, or produce a yield prediction. In one embodiment, this decision may be wirelessly transmitted to the grower via any known method of wireless transmission including cell phone text message, email, pager alert, SMS (short message service), MMS (multimedia message service) radio frequency, World Wide Web, mobile Web or others. In one embodiment, the grower may then execute the decision by manually turning the irrigation system on or off or by logging onto the computer and remotely turning the irrigation system on or off. In one embodiment, the grower may also choose to have his system automated so that the irrigation decision is transmitted to the base station 34 for execution. In one embodiment, the field base station 34 is wired into the irrigation system 38 and can automatically start or stop the irrigation by opening or closing the valves in the specified zones. In one embodiment, simultaneously with the computer's transmission of a control command to the field based controller, the computer may also send an alert to the grower, advising of the irrigation change that has been made. The grower may choose to remotely override the change. In one embodiment, the end user may request “quiet times” during which the computer does not send him alerts.

In one embodiment, the central computer is capable of storing the data and acting as the web server 36 in such a manner that the data and outputs of the algorithms can be used for later viewing and further analysis by an end user.

In some embodiments, the field base station 34 may also have settings so the grower can remotely instruct it to perform tasks such as adjust rates of water or a topical application, activate the stop or start relay for an electric irrigation well, or activate solenoids to flush the filtration system.

The disclosed method and system enables the grower to assess and fully control his crops from the comfort of his office or the mobility of his cell phone.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215, which can include without limitation a mouse, a keyboard and/or the like; and one or more output devices 220, which can include without limitation a display device, a printer and/or the like.

The computer system 200 may further include (and/or be in communication with) one or more storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 230 may permit data to be exchanged with a network (such as the network described below, to name one example), with other computer systems, and/or with any other devices described herein. In many embodiments, the computer system 200 will further comprise a working memory 235, which can include a RAM or ROM device, as described above.

The computer system 200 also may comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 225 described above. In some cases, the storage medium might be incorporated within a computer system, such as the system 200. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the invention. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer readable medium, such as one or more of the storage device(s) 225. Merely by way of example, execution of the sequences of instructions contained in the working memory 235 might cause the processor(s) 210 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 200, various computer readable media might be involved in providing instructions/code to processor(s) 210 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 225. Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

A wide variety of data parameters may be programmed into the central computer as desired. For example, in one embodiment, when there is a significant amount of rainfall detected at the field, the central computer will send a signal to the field based controller to stop irrigation. Contemporaneously, the central computer will send a message to the end user, stating that a certain amount of rain has been measured and that the irrigation has been stopped. An end user will have the option to override the automatic signal sent to the field based controller if desired.

In another embodiment, the data collection devices will have the capability to collect data to help predict predicted environmental variables (weather changes). The algorithms will use the data to correlate how much water the plant needs to maintain its optimum growth, taking into account the plant's canopy temperature and the environmental and predicted environmental variables. For example, if the plant were somewhat thermal stressed, however, the system predicted low temperatures and a high chance for rainfall in the next twelve hours, it would be wasteful to run the irrigation system. The algorithms might generate the decision to delay irrigation under the circumstances.

Some growers may want the software to take note of commodities market changes and correlate those price ranges into the decision of whether to irrigate. Other growers may want to program certain critical life cycle stages, such as germination or blooming, of the plant's growth so that the computer takes these into account when making the irrigation decision.

There are certain times in a plant's life cycle where it may be beneficial for the plant to receive more or less water. For example, during germination, a plant may benefit from additional water. If the projected weather forecast includes rain, or even if it does not, it may be prudent to avoid watering, even if the plant exhibits stress. There are times when a grower may decide not to water, even if direct biological data reflects plant stress, due to changes in the market or changes in his projected crop income. All of these parameters and more can be programmed into the existing computer software to help tweak the irrigation decision depending on the grower's strategy.

In some states, there are periods of time when growers are not allowed to water, or are only allowed to water certain zones. Knowing which zones are in most need of water based on the plant type, plant life stage, and plant stress would help a grower to determine which zones to turn off when required to limit water usage. In conjunction with the collected biological and environmental data, a sound watering decision is reached. Some growers may want to monitor energy costs and correlate those numbers as additional criteria for determining whether to irrigate.

Another beneficial data measurement easily incorporated into this system is the pressures and flows of an irrigation system. In an embodiment, where the field base station is a transceiver, the controller may receive data from sensors capable of measuring pressure changes in the irrigation system. Changes in pressure outside specified parameters could trigger an alarm delivered from the field base station (via two way radio) to the central computer and from the central computer, wirelessly to the end user in the form of cell phone text message, email or other wireless means.

The hardware and software platform designed and used for the disclosed method and system are adaptable to many types of sensors, for example even analog sensors. The platform can define data from multiple types of sources. The benefit of this specially designed platform is that the operator need not change hardware or software in order to read new types of data. The platform has the ability to easily collect and interpret various types of known and unknown data. The system has an efficient protocol and can be run with very little memory. This in turn reduces cost.

In one embodiment, the disclosed system and method can be used for plant variety characterization. In one embodiment, the system and method can monitor a plant variety to determine how it performs in response to stress from various causes of plant stress. In one embodiment, the method and systems can be used to compare one variety to another, for example, to determine which variety has preferable traits which allow for better crop condition or yield in the presence of stress. If two varieties differ by a known trait, the disclosed system and methods can be used to determine how the trait influences crop condition or yield in the presence of stress. Traits which may be identified as significant by the system and method include, but are not limited to, plant height, leaf thickness, maturity (early or late), drought tolerance, pest resistance, and disease resistance. In one embodiment, any morphological or biochemical trait may be identified as significant. In another embodiment, the plant variety can be characterized for its response to topical applications.

In one embodiment, the disclosed system and method can be used to generate a management decision with regard to any number of plants, including, but not limited to corn, soybeans, cotton, grapes, wheat, fruit trees, vegetable plants, grains, and vine crops.

### EXAMPLES

### Example 1

### Water Management

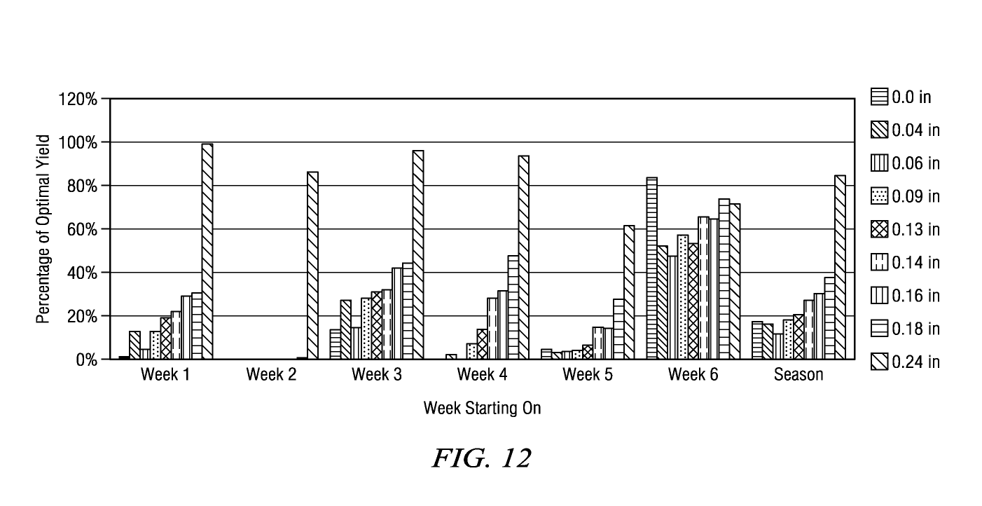

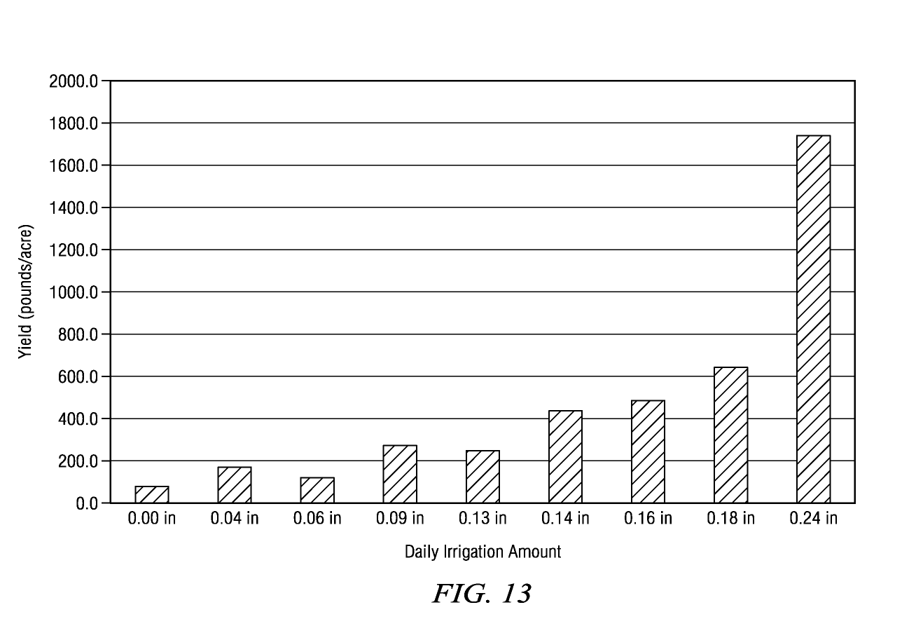

The inventors partnered with Texas Tech University at the research farm location on Quaker Ave in Lubbock, TX in 2011 on a water regression trial. This trial consisted of twelve cotton varieties, which were grown under nine different irrigation regimes. This water regression trial consisted of a dryland check and eight different daily irrigation amounts, including 0.04, 0.06, 0.09, 0.13, 0.14, 0.16, 0.18, and 0.24 inches. The results showed the predicted percentage of optimum yield through out the season. The results demonstrated that variations in the amount of water can be tracked using the system and method disclosed. See FIG. 12 and FIG. 13.

### Example 2

The plant canopy temperature was collected using an infrared temperature sensor that was located in the field with the crop. The temperature was measured and reported every 15 minutes. In Example 1, IRT sensors were placed in each plot that has a unique irrigation schedule. Ambient temperature was captured every 15 minutes by a sensor located at the Base Station. Data from sensors including the IRT, Ambient, Rain Gauge, Soil Moisture Monitoring, Irrigation Flow and Pressure Monitoring, and other data are collected remotely by the Base Station and then sent to the Smartfield Servers for processing.

The USDA had developed a standard method for identifying Optimal Plant Canopy Temperature (OPCT) for several different types of crops. The inventors used a variant method from the standard OPCT to produce the findings in Example 1

### Example 3

The Base Station sent the collected data to the Server via wireless communication. In Example 2, a wireless modem was used to send the data to the server and also receive confirmation that it was successfully received. Once the server received the data it was stored in a database to be used in the Smartfield algorithms and analytics to create information to aide in irrigation management decisions, crop management decisions, or comparing irrigation treatments.

### Example 4

The Stress and Temperature Graph shown in Smartfield's website give users information and recommendations based on the accumulated stress that exceeds a standard accumulated stress setting. Once exceeded, the site gives a visual intervention signal and/or can send an alert to the user via text or email. FIG. 1, FIG. 3 and FIG. 5 represent examples of graphs generated on the website or sent in the alert.

### Example 5

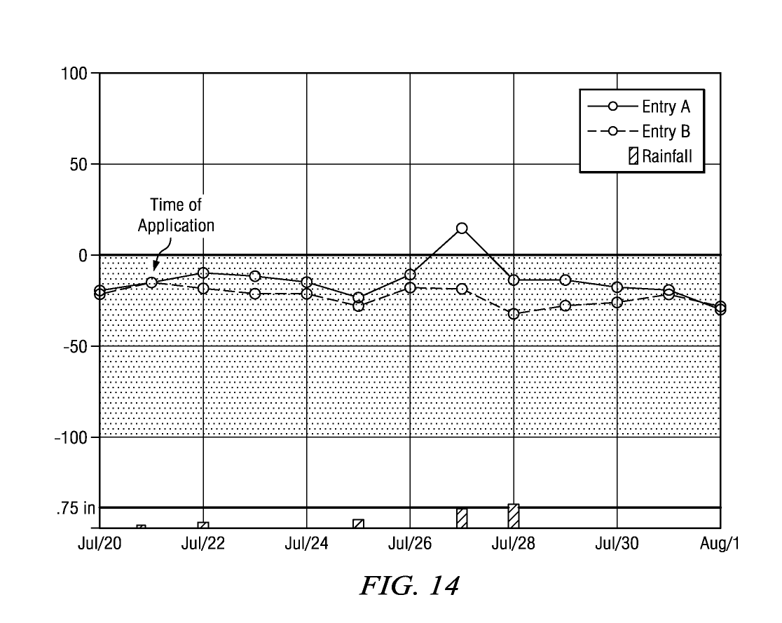

The inventors performed a test to observe whether the application of a topical application to monocot plants results in a difference in stress on the plants. After topical application, the entries illustrate significantly different thermal patterns as viewed through Smartfield Stress Index, as shown in FIG. 14.

### Example 6

Intervention Signals

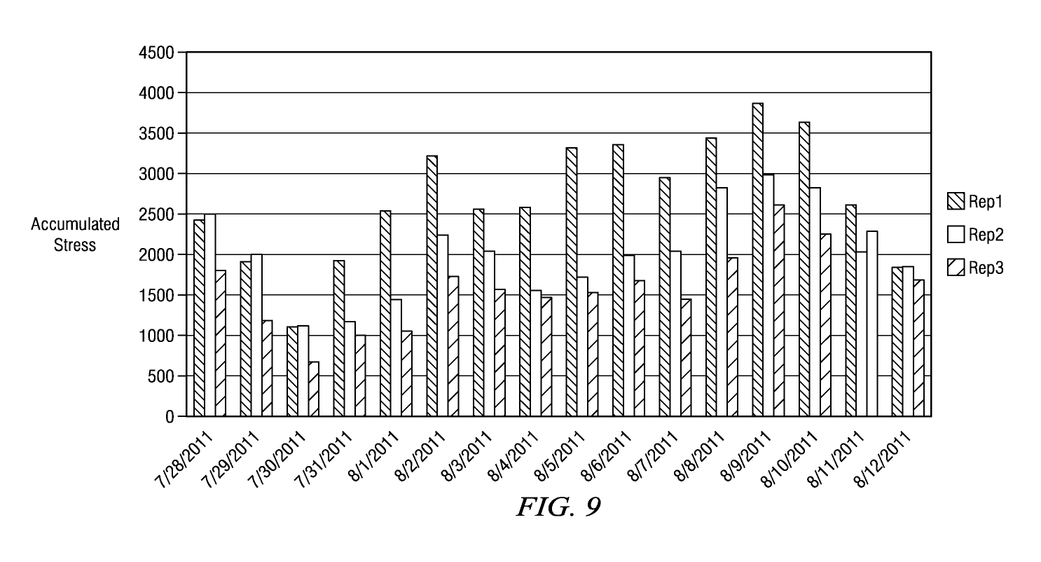

In most typical seed trait trials, the researcher will set up several different scenarios in which to test the seed. The researcher in this example also set up multiple replications of each test at each field. In FIG. 9, the systems and methods of certain embodiments were used to help quantify the quality of the test environment and the variation between the replications themselves. The information that resulted early in the season showed a distinct difference between replications of the same test. Around Aug. 8, 2011 the researcher investigated the field and discovered that the area of the field in which Rep 1 was located had a very concentrated weed infestation. The analytical method clearly showed an intervention signal as early as Jul. 31, 2011 that could have been used to help control weed impact on the crop. The plants' ability to fight off diseases, pests, weeds, and other afflictions weakens as the plants accumulated stress levels increase. By seeing this indication of increasing stress earlier in the season, the producer could have been able to react sooner with topical treatments to limit the harmful impact on the crops yield potential and overall quality.

### Example 7

### Genotypic/Trait Selection

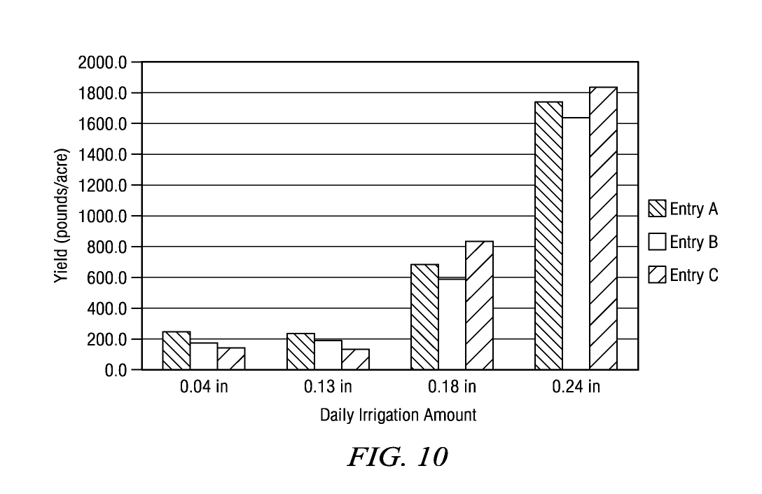

In a typical genotypic/trait selection process the research company sets up multiple test sites across varying regions, climate zones, soil types, irrigation levels, and management practices. The use of the systems and methods of certain embodiments allows the researcher to better manage the trials, identify variability between replications and tests, and quantify product performance both during and at the conclusion of the trial. In FIG. 10, there are 3 cotton entries that show their varying abilities to handle the specific stress loads in which they were managed. Entry A showed superior performance in low irrigation conditions where as Entry C showed to be superior if higher irrigation levels are available. Entry B performed poorly across all irrigation levels and would be a candidate to be removed as a future production product.

### Example 8

### Yield Prediction

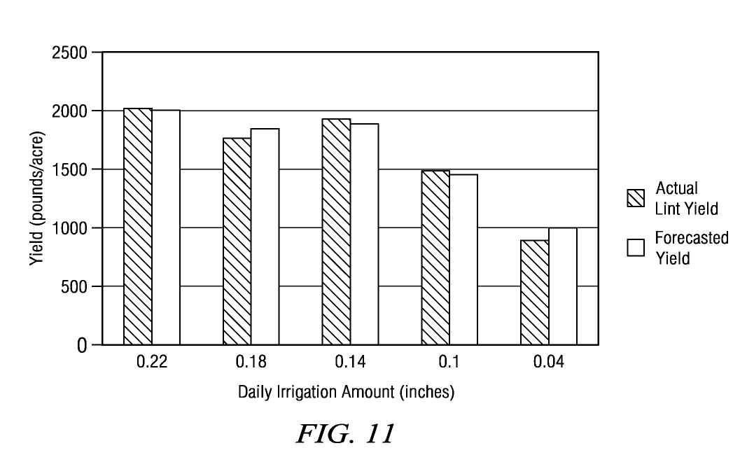

A Water Regression Study was performed at Texas Tech in 2009. The study shows the results of the year-end yield forecast compared to the actual yield (FIG. 11). Using the systems and methods of certain embodiments, the yield predictions were generated throughout the season and prior to the harvesting of the cotton crop. FIG. 11 shows the actual yield and the predicted yield for the different entries that were grown under the same management conditions at the end of the season. The same analytical methods can be used through out the season to predict yield and identify variety lines and hybrids best and worst performers.

### Example 9

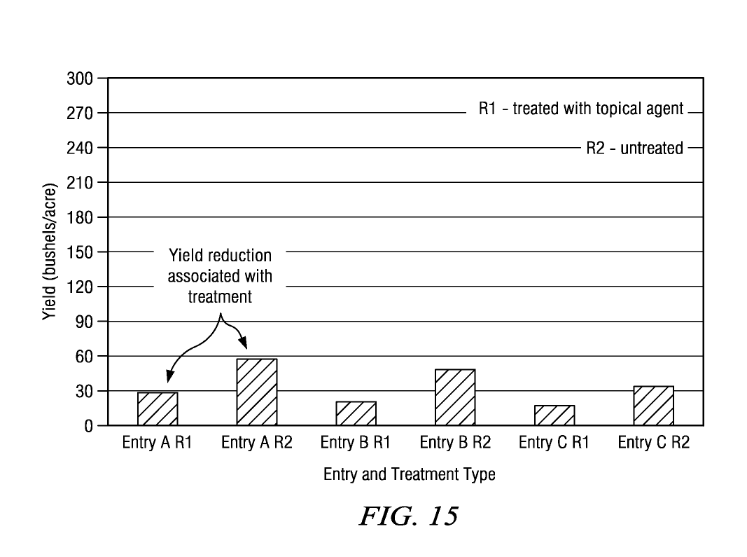

A crop of cotton plants are planted by a grower that typically applies a topical application, Brand A herbicide, which increases the field stress by up to 15% for a period of approximately 3 days. Because of the increase in stress, the farmer can expect a proportional decline in yield depending on the time of the application. By monitoring the seasonal stress accumulation the grower can alter the timing of the application or can alter other field inputs to reduce the level of stress prior to the application. For example, applying the topical agent during a cool front or starting the application at night, as opposed to during the day, can be used to diminish the effect of the increase in stress following the application. See FIG. 15.

### Example 10

In this example, corn crops are grown during a season of high temperatures and low rainfall. It has been identified that after periods of high stress a particular topical application, Brand A fungicide, can reduce plant stress between 0 to 25% depending on the stress level at the time of application. By monitoring the seasonal stress accumulation the grower can time the application of the topical agent to maximize its effectiveness and as a result maximize yields. By observing the seasonal stress the grower can compare the amount of stress accumulation to the potential benefits of reducing the accumulated stress and the cost associated with applying the topical agent. The grower or consultant can use Activity-Based Costing to determine impact of applying the topical agent on the field's overall rate of return.

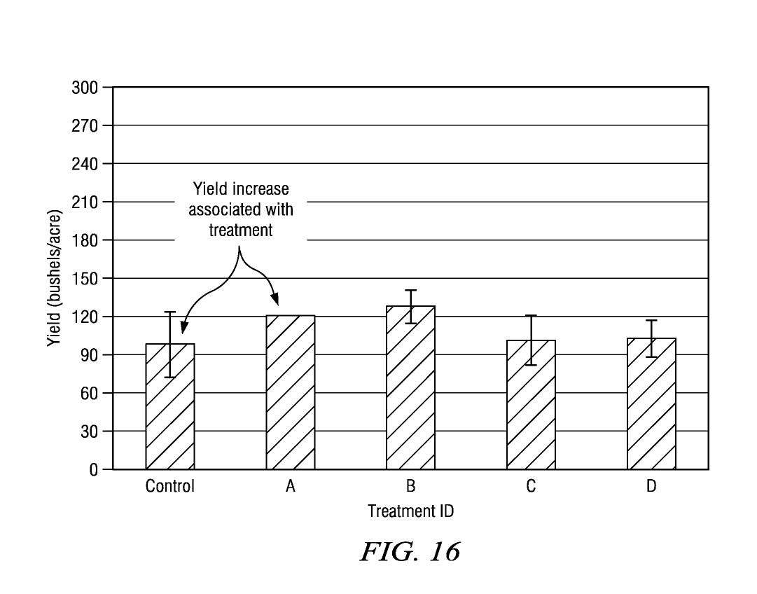

In the example chart of FIG. 16, near optimal timing of the application of Treatment A results in a reduction of plant stress and as a result an increase in yield for the treated entry of over 30%.

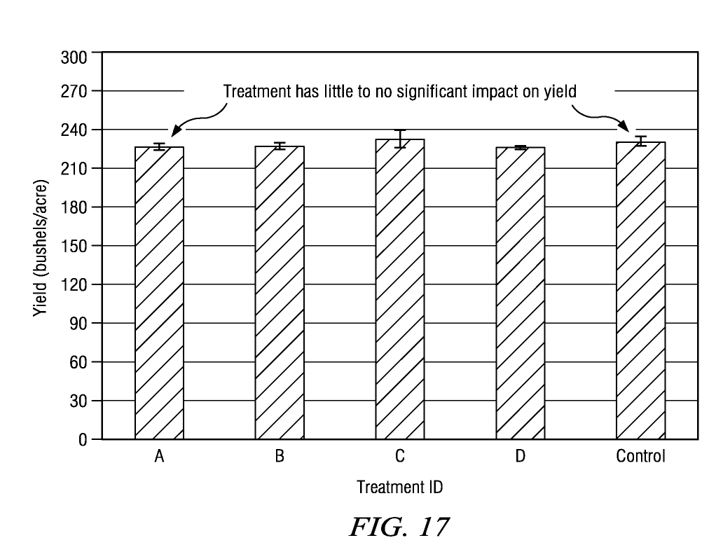

In the example chart of FIG. 17, poor timing of the application of Treatment A results in minimal change to the plants stress levels. In this example, the grower's cost of the topical application would outweigh any benefit that he might receive.

The two examples show applying topical agents under different conditions will have a measureable variance using the systems and methods of certain embodiments.

### Example 11

### Example of Programming the Trigger by Yield Prediction

In this example, a grower uses yield prediction analysis in addition to the leaf temperature analysis in order to lower water use. The grower is managing a crop growing in a desert region where there is tight competition for available water between household use, agricultural use, and commercial use. The grower sets the trigger level so that he will not achieve lower than a 70% predicted yield. The field is planted, and leaf temperature sensors are put into place in the field. The sensors are able to communicate with a field base station, which can communicate with a central processor. The grower is alerted by cell phone whenever he must initiate watering immediately to prevent having a predicted yield of less than 70%.

A graphical display of his water savings by using these methods is made available to the local water board and to the local community by internet access to the grower's website. By demonstrating that his crops grow well with out wasting water, the community supports the presence of his agricultural fields in the local area, even when there is a high competition for water use.

### Example 12

### Example of Managing Irrigation During Drought Periods

A tomato crop is growing in an area that is experiencing a season of abnormally low precipitation. In order to help with the water-deficit issues, the grower decides to set the crop irrigation so that irrigation is automatically turned on every day when the crop reaches an accumulated time-temperature count (temperature above optimum) X (time above optimum) of 1,100. Each day, the count is restarted at 0. The grower uses multiple field leaf canopy temperature sensors placed throughout the field to measure the leaf temperature. The readings are transmitted to a central computer, which is automatically set to initiate drip irrigation when the pre-determined accumulated stress count number (1,100) is reached.

By using this method, the grower can still achieve an acceptable crop yield, while not wasting the local area's water resources. A graphical display of his water savings (similar to the graphs shown in FIG. 1) is made available to the public at the end of every season.

### Example 13

### Example of Testing for the Best Low Water Variety for a Particular Region

A grower obtains seeds of several water-deficit resistant and heat resistant varieties of wheat in order to test these varieties for their suitability for growing under a slight water deficit in a particular region that often experiences ambient temperatures of over 102° F. Each of the varieties is planted in a ½ acre test plot. The grower places canopy temperature sensors throughout each of the test plots. The sensors are set so that they take a reading every five minutes. The ambient temperature is measured every 10 minutes throughout the day. The plants are irrigated with 0.1 inches of water per day. In addition, the grower also uses the “Smartfield Stress Index” calculation to determine when to apply additional irrigation to the crop. He doesn't want to waste water, but he still wants to reach a high yield. Therefore, he plans to set a trigger so that the irrigation pivots are automatically initiated whenever the “Smartfield Stress Index” level reaches a reading of −75 or above.

By use of this method, he can determine the seasonal water use total for each of the varieties, as well as the yield of each of the varieties. At the end of the season, the grain yield, as well as the total seasonal water use, is calculated for each separate variety. The grower then selects which of the test varieties he will plant the next year, based on the characteristics of high yield and efficient water usage.

### Example 14

### Example of Setting a Trigger for a Plant that is Sensitive to Water Deficit

A crop of basil plants that is particularly sensitive to water stress is planted in a field. The grower places several canopy sensors in the field, and sets them to take a reading every minute. Because this type of plant is known to wilt readily when experiencing water deficit, the grower sets the trigger so that drip irrigation will be automatically initiated whenever the plants reach an accumulated stress count, (that is, temperature above optimum X minutes above optimum) of 50. The system is also set up so that the grower is alerted of the irrigation, and is able to view real time data and graphs of the crop status through a link to a central web page. By use of this method, the plants are kept at near optimal temperature and water use during the entire season. At the end of the season, the yield of high quality basil leaves is about 15% higher than in previous years.

### Example 15

### Example of Basing the Crop Canopy Temperature Trigger on a “High Stress” Level

A grower plants a field of zucchini squash. The grower decides to set the trigger for alerting an automatic watering control device based on the number of minutes that the crop is experiencing an elevated leaf canopy temperature that is indexed as “high stress” (for this particular zucchini crop, it's 4° C. above the optimal temperature). When the canopy temperature sensors show that the plants have been at this “high stress” level for more than 30 minutes, a one hour period of drip irrigation is automatically initiated. The sensors continue to monitor the field throughout the day, and a trigger will be set off again, later in the day, if there is another period of 30 minutes where the crop is at the “high stress” level.

### Example 16

### Example of Setting the Trigger to Result in Very Low Irrigation of a Crop where High Water Costs are Limiting to Agricultural Production in a Region

A crop of radish plants is planted in an area where water availability is very low. In addition, the water cost in this area is very high. The grower knows that he can only break even on the crop if he uses as little daily water as possible. He places the canopy temperature sensors in the field, and measures the ambient temperature of the local area using a sensor on a field base station. The data is transmitted to a central computer, which determines the “Smartfield Stress Index Score” every 15 minutes throughout the day. The grower freely waters the plants until the plants are 2.0 inches above ground. After that point, the grower adjusts the trigger so that he is alerted whenever the plants reach a “Smartfield Stress Index Score” of −25 or higher, which is a relatively high water deficit situation. Once he is alerted, he decides whether or not to initiate irrigation immediately. He sets the trigger so that if, for some reason, he doesn't respond either way to the alert, another trigger is set to send an alert to the automated irrigation system when the “Smartfield Stress Index Score” reaches −20.

### Example 17

### Example of Monitoring Irrigation of Commercial Garden Centers

There are many commercial garden centers that sell potted plants of all sizes to the public. This example demonstrates how embodiments of the invention can be used to efficiently keep water-deficit sensitive plants healthy even when they are not monitored constantly by human intervention. A large company with multiple nation-wide garden centers needs to keep its labor costs low. However, many of its garden centers are in hot or dry regions, where summer temperatures can reach over 100° F. on a daily basis. The garden center has many hanging basket plants for sale, but these plants require much more monitoring and more water per plant than the other plants on sale at the garden center. Many of the hanging basket plants die or cannot be purchased at full price because they are not carefully monitored and irrigated as often as needed by the garden center staff.

The garden center's main office obtains plant canopy sensors and places them above the areas where the hanging plants ready for sale are displayed to the public. The sensors are set to measure the plant canopy temperatures of the hanging pots every 2 minutes. Ambient temperature is also measured every 6 minutes. The information is sent to a base station at the particular garden center, and from there it is relayed to the central processing computer, where data analysis is performed. Triggers are set up so that an irrigation control device is alerted to initiate automatic irrigation of the hanging plants using overhead automatic sprinklers whenever the “accumulated stress count” (canopy temperature above optimal)×(minutes above optimal) reaches 100. The daily accumulated stress counts, water usage, number of hanging plants sold, percentage of plants that have died (or are rendered unsuitable for sale due to excess heat and water deficit stress), and other data is made available to the company's central management office by use of a computer network. The central management office then uses the information from the different garden centers to adjust the trigger levels for different locations as needed. For example, the accumulated stress count trigger levels are lowered to 50 in certain garden center locations that have extremely high afternoon heat, or where the data shows that a higher percentage of plants have died due to plant water-deficit stress.

By use of this method, the garden centers are able to sell more than 90% of their hanging plants, making that section of their total sales about 35% more profitable. They are able to lower labor costs by not needing as many workers at each of the garden center locations, and they are also able to lower their financial losses because they have a lower number of hanging basket plants that have to be discarded.

While the disclosed method and apparatus has been described in conjunction with certain embodiments thereof, many changes, modifications, alterations and variations will be apparent to those skilled in the art. The invention should therefore not be limited to the particular embodiment disclosed but should include all embodiments that could fall within the scope of the claims.

Accordingly, the embodiments of the invention shown in the drawings and described in detail above are intended to be illustrative, not limiting, and various changes may be made without departing from the spirit and scope of the invention as defined by the claims set forth below

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method for generating a crop management decision, the method comprising the steps:
a. Collecting crop canopy temperatures at timed intervals;
b. determining, with a computer system, a crop condition based at least in part on the collected canopy temperatures or a value derived therefrom; and
c. generating, with the computer system, a management decision, wherein the management decision is selected from (i) a characterization of a plant variety, (ii) a decision to start or stop application of a topical application, wherein the topical application is a pesticide, growth regulator, growth hormone, herbicide or fungicide, and (iii) a prediction of future yield; or the method comprises the steps:
d. collecting crop canopy temperatures at timed intervals;
e. storing, in a computer readable format, a known crop specific optimum growing temperature or optimum canopy temperature;
f. calculating, using a computer system, an accumulated stress score;
g. determining, with the computer system, a crop condition based at least in part on the accumulated stress score or a value derived therefrom; and
h. generating, with the computer system, a management decision.

2. The method of claim 1, further comprising:
collecting ambient temperature at regular intervals; and
calculating, with the computer system, a Smartfield Stress Index value, wherein determination of the crop condition is based on the Smartfield Stress Index value.

3. The method of claim 1, further comprising:
determining crop specific ranges of canopy temperatures above optimal temperature;
classifying the crop specific ranges of canopy temperature above optimum in order of crop impact;
quantifying, with the computer system, the amount of time the collected crop canopy temperatures were in each of the specific ranges.

4. The method of claim 1, wherein the management decision is a decision to start or stop irrigation.

5. The method of claim 1, wherein the management decision is a prediction of future yield.

6. The method of claim 1, wherein the management decision is a characterization of a plant variety.

7. The method of claim 6, wherein the characterization of a plant variety is selected from the group consisting of: (i) the condition of the plant variety, (ii) the indentification of a variety with preferable traits, (iii) the determination of the effect of a trait on crop condition or yield and (iv) the effect of applying a topical application to the variety.

8. The method of claim 1, wherein the management decision is a decision to start or stop application of a topical application, wherein the topical application is selected from the group consisting of a pesticide, a growth regulator, a growth hormone, an herbicide and a fungicide.

9. The method of claim 1, wherein the management decision is a decision to inspect a crop for causes of stress.

10. The method of claim 1, further comprising the collection of weather data or soil data.

11. The method of claim 1, wherein a management decision is generated when the accumulated stress score reaches a predetermined level.

12. The method of claim 1, wherein the management decision comprises sending an alert to a user.

13. The method of claim 12, wherein the user is selected from the group consisting of: a grower, a farmer, an agricultural worker, an agricultural management service, and a company management team.

14. The method of claim 12, wherein the alert is sent to the user via a device selected from the group consisting of: a telephone, a cell phone, an email account, a text message, an SMS message, a pager, a website, an automated irrigation control device, a remote irrigation control device, or a communication device.

15. The method of claim 1, further comprising transmitting data to an internet website or other accessible system.

16. The method of claim 15, wherein the said internet website or other system is accessible to an individual or a group selected from the group consisting of: the grower, the public, a specialized water management organization, an organization of farmers, an irrigation district organization, an association of water users, an agricultural insurance company, and an agricultural investment company.

17. The method of claim 1, wherein the management decision is provided on a graphical display.

18. The method of claim 17, wherein the graphical display is provided by email, a website or on paper.

19. The method of claim 17, wherein the graphical display comprises a visualization of the accumulated temperature stress of a crop, comprising:
a line indicating the optimal canopy temperature for said crop;
a line graph of the ambient temperature taken at intervals; and
a line graph of the crop canopy temperature taken at intervals.

20. The method of claim 17, wherein the graphical display comprises a visualization of the accumulated temperature stress of a crop, and wherein specific ranges of canopy temperature above optimum are color coded.

21. The method of claim 17, wherein the graphical display comprises a visualization of the accumulated temperature stress of a crop, comprising:
a line indicating the optimal canopy temperature for said crop; and
a bar graph indicating the amount of time that the crop canopy has been experiencing a level of temperature stress over the optimal canopy temperature.

22. A system to monitor and respond to crop condition, comprising:
a. one or more devices to collect crop canopy temperature at timed intervals; and
b. a computer system, comprising:
i. a processor; and
ii. a computer readable medium having encoded thereon a set of instructions executable by the processor to cause the computer system to perform one or more operations, the set of instructions comprising:
(A) instructions for receiving the collected crop canopy temperatures;
instructions for a determining a crop condition based at least in part on the collected canopy temperatures or a value derived therefrom; and
instruction for generating, a management decision, wherein the management decision is selected from (i) a characterization of a plant variety, (ii) a decision to start or stop application of a topical application, wherein the topical application is a pesticide, growth regulator, growth hormone, herbicide or fungicide, and (iii) a prediction of future yield;
or the set of instructions comprising:
(B) instructions for storing a known crop specific optimum growing temperatures or optimal canopy temperature;
instructions for receiving the collected crop canopy temperatures;
instructions for calculating an accumulated stress score;
instructions for determining a crop condition based at least in part on the accumulated stress score or a value derived therefrom; and
instructions for generating a management decision.

23. The system of claim 22, further comprising a device to collect ambient temperatures at timed intervals, and wherein the computer readable medium further comprises instructions for receiving the collected ambient temperatures.

24. The system of claim 22, further comprising a device suitable to transmit a management decision, and wherein the computer readable medium further comprises instructions to transmit a management decision.

25. The system of claim 22, further comprising sensors for collecting weather or soil data, and wherein the computer readable medium further comprises instructions for receiving the collected weather or soil data.

26. The system of claim 22, further comparing an automated irrigation system or topical application system which may be activated or deactivated in response to the management decision.
